(19) United States
(12) Patent Application Publication
(10) Pub. No.: US 2026/0289160 A1
(43) Pub. Date: Sep. 24, 2026

(54) SYSTEM

(71) Applicant: SoftBank Group Corp., Tokyo (JP)

(72) Inventor: Hitomi WATARIGUCHI, Tokyo (JP)

(73) Assignee: SoftBank Group Corp., Tokyo (JP)

(21) Appl. No.: 19/560,183

(22) Filed: Mar. 9, 2026

(30) Foreign Application Priority Data
Mar. 19, 2025 (JP) 2025-044542

(51) Int. Cl. G06F 40/40; G06F 40/205; G06F 40/284; G06N 3/0455; G06N 3/0475

(52) U.S. Cl. CPC G06F 40/40; G06F 40/205; G06F 40/284; G06N 3/0455; G06N 3/0475

(57) ABSTRACT

A system includes a processor that is configured to provide an interface for receiving information from a user, analyze the received information using natural language processing techniques and evaluate an emotional state of the user, and create a prompt sentence for instructing a generative AI model to generate a next question based on a result of the emotional analysis.

### CROSS-REFERENCE TO RELATED APPLICATION

This application is based on and claims priority under 35 USC 119 from Japanese Patent Application No. 2025-044542 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional diary systems and interactive applications that collect user input typically rely on fixed, rule-based question flows or simple keyword analysis. Such systems are unable to accurately assess a user's emotional state from free-form natural language input and cannot flexibly adapt subsequent questions to the user's current feelings or context. As a result, the interaction often feels mechanical, and the generated diary content does not sufficiently reflect the user's inner emotional experiences. Furthermore, many existing systems do not effectively use advanced generative AI models in combination with emotion analysis to dynamically generate questions and diary entries, leading to limited personalization and expressiveness. There is therefore a need for a system that can receive user input in natural language, accurately evaluate the user's emotional state, and automatically generate context-sensitive follow-up questions and diary content based on such emotional analysis.

### SUMMARY

In order to solve the above-described problem, an aspect of the present invention provides a system comprising a processor, wherein the processor is configured to provide an interface for receiving information from a user, analyze the received information using natural language processing techniques and evaluate an emotional state of the user, and create a prompt sentence for instructing a generative AI model to generate a next question based on a result of the emotional analysis. The processor is further configured to input the prompt sentence into the generative AI model and generate a question to be presented to the user. In addition, the processor is configured to store an answer from the user in a database and automatically generate a diary based on contents of the answer and the result of the emotional analysis. By integrating natural language processing-based emotion evaluation with prompt generation for a generative AI model, and by recording user answers together with emotional analysis results for automatic diary creation, the system enables adaptive, emotionally aware questioning and the generation of diary content that more accurately reflects the user's internal emotional state.

The term “system” refers to a combination of hardware and software components including at least one processor, memory, and associated interfaces, configured to execute the functions described in the claims.

The term “processor” refers to one or more central processing units (CPUs), microprocessors, microcontrollers, digital signal processors (DSPs), graphics processing units (GPUs), dedicated AI accelerators, or other programmable logic devices that execute instructions to perform the specified processing.

The term “interface” refers to a hardware or software component, or a combination thereof, that enables input of information from a user, including but not limited to graphical user interfaces, command line interfaces, application programming interfaces, touch input interfaces, voice input interfaces, and network communication interfaces.

The term “information” refers to any data provided by the user, including but not limited to text, voice, images, selections, or other input signals that express the user's thoughts, experiences, or emotions.

The term “user” refers to a person who interacts with the system by providing information, receiving questions, and reviewing generated diary content.

The term “natural language processing techniques” refers to algorithms and methods for processing and analyzing human language, including but not limited to tokenization, part-of-speech tagging, syntactic parsing, semantic analysis, sentiment analysis, and emotion classification.

The term “emotional state” refers to an internal affective condition of the user, such as happiness, sadness, anger, anxiety, calmness, or other emotional categories or dimensions inferred from the user's information.

The term “emotional analysis” refers to processing that estimates or classifies the emotional state of the user based on the received information using natural language processing techniques and related algorithms.

The term “generative AI model” refers to a machine learning model configured to generate text or other content in response to an input, including but not limited to large language models, transformer-based models, or other neural network-based generative models.

The term “prompt sentence” refers to text or structured data generated by the processor and supplied as an input to the generative AI model in order to instruct the generative AI model to generate a next question or other content.

The term “next question” refers to an interrogative sentence or a set of interrogative sentences generated by the generative AI model based on the prompt sentence and intended to be presented to the user as a follow-up in an interactive sequence.

The term “question to be presented to the user” refers to a next question or any other interrogative content generated by the generative AI model that is transmitted from the system and displayed or otherwise output via the interface to the user.

The term “answer” refers to a response provided by the user to a question, including but not limited to text entered by the user, voice that has been converted to text, or other structured or unstructured response data.

The term “database” refers to any structured data storage system, including relational databases, key-value stores, document stores, or other persistent storage mechanisms, used to record and manage the user's answers and related analysis results.

The term “diary” refers to a record automatically generated by the system for a given period, including at least one natural language text describing the user's experiences, thoughts, or emotions, and based on the user's answers and the emotional analysis results.

The term “automatically generate a diary” refers to processing in which the processor creates the diary without requiring manual drafting of the diary text by the user, by using the stored answers and emotional analysis results as input to an algorithm or model that produces natural language text.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

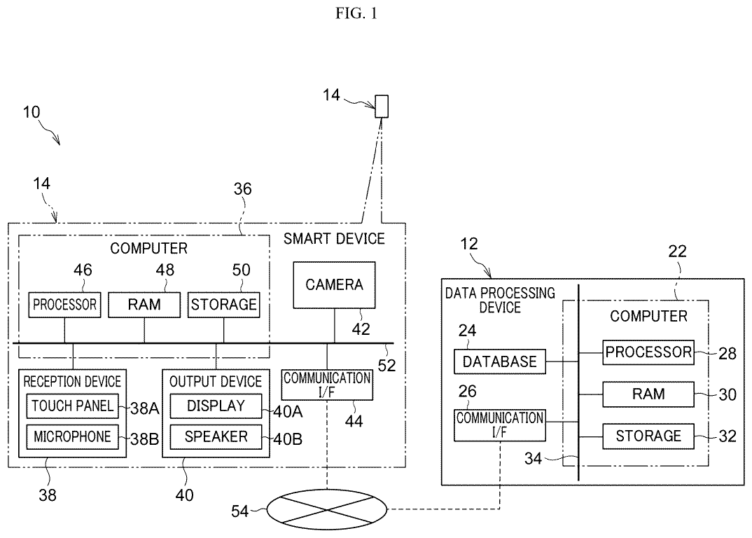

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

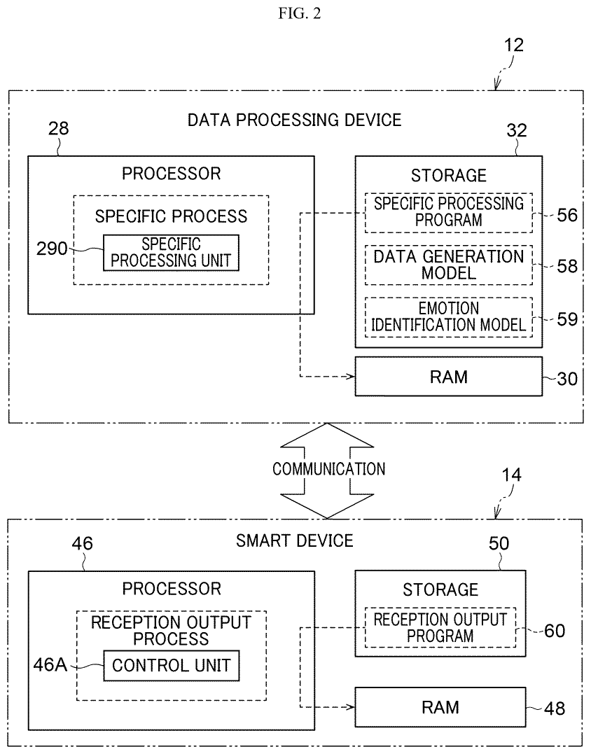

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented diary systems that use conversational interfaces suffer from several technical limitations in how they process, store, and exploit user-generated text data. In many existing systems, a server presents pre-defined or template-based questions to a user and simply stores user answers as unstructured text. Such systems typically do not maintain a machine-usable representation of user emotional states or topics over time, and therefore cannot adapt subsequent questions in a technically meaningful, fine-grained manner. As a result, the interaction logic is largely static, and the server cannot effectively utilize past data to control future generation behavior of a machine learning model.

Furthermore, when a generative artificial intelligence model is used in a naive manner, the server often provides only the immediately preceding user message as context, or passes raw text history without structured analysis. This approach causes several technical issues: (i) inefficient use of computation and memory resources on the server, because large unstructured histories must be repeatedly reprocessed; (ii) unstable or unpredictable output from the generative model, because the model is not guided by explicit control conditions tied to structured emotion and topic data; and (iii) difficulty in systematically reproducing or controlling question generation behavior, since there is no explicit policy or state representation that the server can manipulate.

Additionally, many existing systems do not integrate natural language processing analysis, user-specific historical data, and database-backed diary records into a cohesive control loop for prompt construction. The absence of a structured “user context data” layer and associated “prompt sentence creation policy” means the server cannot programmatically steer the generative model towards targeted follow-up questions that reflect long-term emotional trends, topic distributions, and diary summaries. This leads to technically suboptimal utilization of the generative model, reduced personalization quality, and an inability to efficiently generate higher-level reflective questions (e.g., daily, weekly, or monthly summaries) without manually designed rules.

There is therefore a need for a computer-implemented technique in which a server (i) systematically analyzes user text using natural language processing to extract emotions and topics, (ii) maintains this information as structured user context data across sessions in a data management device, and (iii) uses this data to construct constrained prompt sentences with explicit control conditions for a generative artificial intelligence model. By closing the loop among analysis, structured storage, and controlled prompt generation, the server can improve the technical functioning of the system, including more stable and controllable model outputs, more efficient data reuse, and more robust generation of adaptive, context-aware questions for diary creation and reflection.

The specific processing by the specific processing unit 290 of the data processing device 12 in Example 1 is realized by the following means.

The present invention provides a server comprising a processor configured to provide an information input/output interface for receiving text data from a user via a terminal device; analyze, by using a natural language processing technique, the text data obtained from the user to perform preprocessing including sentence segmentation, word segmentation, part-of-speech tagging, emotion estimation, and topic extraction, and to generate an analysis result including at least an emotional state and an area of interest of the user; acquire the analysis result and a past answer history for each user stored as structured data in a storage device, and generate user context data integrated in time series based on the analysis result and the past answer history; create, on the basis of the user context data, a prompt sentence to be input to a generative artificial intelligence model, and add control conditions to the prompt sentence so as to constrain an output of the generative artificial intelligence model to a single question sentence while reflecting the emotional state and the area of interest of the user; input the prompt sentence into the generative artificial intelligence model and cause the generative artificial intelligence model to generate, in accordance with the control conditions, a next question sentence to be presented to the user; transmit the next question sentence via a network to the terminal device and cause the terminal device to present the next question sentence through a display user interface; acquire answer text data of the user transmitted from the terminal device and store the answer text data, together with user identification information, question identification information, time information, and the analysis result, in a data management device; automatically generate diary data for each user on the basis of the answer text data and the analysis result stored in the data management device, and store the diary data while maintaining a correspondence between the question sentence and the answer text data; and update, by using the diary data and the user context data, a creation policy of the prompt sentence and a generation policy of the next question sentence for a subsequent session. This enables the server to implement a closed-loop control architecture in which natural language processing analysis, structured user context data, and constrained prompt sentences cooperatively govern the behavior of the generative artificial intelligence model, thereby improving the technical functioning of the diary system by producing more stable, context-aware, and computationally efficient question generation across sessions.

The term “information input/output interface” refers to a hardware and/or software component that enables a server to receive information from and provide information to an external entity, such as a user terminal, through mechanisms including, but not limited to, graphical user interfaces, application programming interfaces, and network communication interfaces.

The term “text data” refers to character-based digital information representing natural language content input by a user or generated by a system, including sentences, phrases, and words encoded in a machine-readable format.

The term “natural language processing technique” refers to a computational method or algorithm that processes and analyzes natural language text, including operations such as tokenization, sentence segmentation, part-of-speech tagging, parsing, semantic analysis, emotion estimation, and topic extraction.

The term “sentence segmentation” refers to a process of automatically detecting boundaries between sentences in a continuous text sequence and dividing the text into individual sentence units.

The term “word segmentation” refers to a process of dividing a character sequence into word units, including tokenization in languages where words are separated by whitespace and morphological segmentation in languages where words are concatenated.

The term “part-of-speech tagging” refers to a process of assigning grammatical category labels, such as noun, verb, adjective, or adverb, to words in a text based on their syntactic and contextual usage.

The term “emotion estimation” refers to a computational process that assigns one or more emotion-related labels or scores, such as joy, sadness, fear, anger, or neutral, to a text input, based on the linguistic content and contextual cues.

The term “topic extraction” refers to a process of identifying one or more subjects, themes, or categories that characterize the content of a text, using techniques such as keyword extraction, clustering, or probabilistic topic modeling.

The term “analysis result” refers to structured data produced by applying natural language processing techniques to text data, the structured data including at least an estimated emotional state of a user and one or more extracted areas of interest or topics.

The term “emotional state” refers to a representation of a user's affective condition, expressed as one or more discrete emotion labels, continuous scores, or distributions over emotion categories, inferred from user-generated text.

The term “area of interest” refers to a subject domain, theme, or category that is determined, based on text analysis, to be relevant to a user's preferences, concerns, or frequently discussed topics.

The term “past answer history” refers to a collection of previously received answer texts, with associated metadata, for a given user, stored over multiple interactions or sessions.

The term “structured data” refers to information organized in a predefined format, such as records, fields, and relational tables, enabling systematic querying, indexing, and processing by computer programs.

The term “storage device” refers to a physical or virtual component that retains digital data, including but not limited to magnetic storage, solid-state storage, optical storage, or network-attached storage.

The term “user context data” refers to aggregated and temporally integrated structured data describing a user's past interactions, emotional states, topics, and related metadata, which is used to characterize the user's situation over time.

The term “integrated in time series” refers to a manner of organizing data such that individual data points are arranged, combined, or summarized according to their temporal order or time stamps.

The term “prompt sentence” refers to a natural language text string constructed for input to a generative artificial intelligence model, the text string instructing or guiding the model to perform a specific generation task, such as producing a question.

The term “generative artificial intelligence model” refers to a machine learning model capable of generating new content in response to input data, including, but not limited to, a neural network-based model that produces natural language text conditioned on a prompt sentence.

The term “control conditions” refers to explicit constraints, instructions, or parameter settings applied to the generation behavior of a generative artificial intelligence model, specifying properties such as output type, output length, style, or content focus.

The term “single question sentence” refers to a natural language output constrained to one interrogative sentence, which is intended to solicit a response from a user.

The term “next question sentence” refers to a question sentence generated by the generative artificial intelligence model, based on a prompt sentence and user context data, and intended to be presented to the user in a subsequent interaction step.

The term “terminal device” refers to a user-operated computing device that communicates with a server via a network, including but not limited to a smartphone, tablet, personal computer, or web client.

The term “display user interface” refers to a graphical or textual presentation layer rendered on a terminal device that visually presents information, such as question sentences and diary entries, to a user and may receive interactive input.

The term “user identification information” refers to data that uniquely or pseudonymously identifies a user within the system, including identifiers such as user IDs, account IDs, or session-linked identifiers.

The term “question identification information” refers to data that uniquely identifies a question instance within the system, enabling association between a question and corresponding user answers and metadata.

The term “time information” refers to data indicating a temporal attribute of an event, such as a creation time, receipt time, or update time, typically represented as a timestamp or date-time value.

The term “data management device” refers to a logical or physical system for storing, organizing, retrieving, and managing digital data, including but not limited to a database system or a data storage server.

The term “diary data” refers to a collection of records that include question sentences, corresponding user answer texts, and associated analysis results, organized in a way that represents a user's diary over time.

The term “correspondence between the question sentence and the answer text data” refers to a relationship maintained in stored data that associates each answer text with the specific question sentence to which the answer responds.

The term “creation policy of the prompt sentence” refers to a set of rules, parameters, or computational procedures used by the server to decide how to construct prompt sentences, including which context information to include and how to express control conditions.

The term “generation policy of the next question sentence” refers to a set of rules, parameters, or computational procedures that determine how the generative artificial intelligence model should generate a next question sentence, given a prompt sentence and context.

The term “subsequent session” refers to a later interaction period between a user and the system, which occurs after one or more prior sessions and may use previously stored diary data and user context data.

The term “summary information” refers to data that condenses or abstracts a larger set of records, such as multiple question-and-answer pairs or analysis results, into a shorter representation suitable for efficient processing or model input.

The term “follow-up question sentence” refers to a question sentence generated to further explore, clarify, or deepen a topic or emotional state that has appeared in prior user answers.

The term “transition of the emotional state” refers to a change or pattern over time in the emotional states associated with a user, as derived from multiple text analyses. The term “change in the area of interest” refers to a variation over time in topics or themes associated with a user, such as the emergence, decline, or frequency shift of specific subjects.

The term “topic distribution” refers to a representation of relative frequencies or weights of multiple topics within a set of diary data, indicating how prominently each topic appears in the data.

The term “predetermined period” refers to a time interval defined by system configuration or program logic, such as a day, a week, or a month, used for aggregation or summarization of data.

The term “aggregation result” refers to data produced by combining multiple records over a predetermined period, including computed statistics or summaries of emotional states and topic distributions.

The term “reflection on a daily unit, a weekly unit, or a monthly unit” refers to a user's review and consideration of experiences and emotional states over a single day, a week, or a month, as prompted by a question sentence generated by the system.

In one embodiment, a server implements the claimed system as a network-accessible diary-assistance platform that interacts with a terminal operated by a user. The server executes an application program on a general-purpose computer system including at least one central processing unit (CPU), a graphics processing unit (GPU), a main memory, a non-volatile storage device, and a network interface. For example, the server uses a processor conforming to an x86_64 architecture, a GPU supporting general-purpose computation, a memory subsystem implemented by a dynamic random-access memory, and a storage subsystem implemented by a solid-state drive. The server executes an operating system such as a general-purpose server operating system, and runs server-side application software built on a web framework such as an HTTP application framework.

The server stores a generative AI model implemented as a neural network, and a natural language processing (NLP) module implemented by one or more trained models and rule-based components. In one embodiment, the server uses a transformer-based language model similar to an autoregressive large language model implemented using a machine learning framework such as a tensor computation library. The generative AI model includes an embedding layer that maps tokens to vectors, multiple transformer blocks including self-attention layers, feedforward layers, and normalization layers, and an output layer that predicts a probability distribution over tokens. The server stores learned parameters of this generative AI model, including weight matrices and bias vectors, in the storage device, and loads them into the main memory at runtime.

The server uses an NLP module constructed with a library such as a natural language toolkit or a transformer-based text classifier. The NLP module performs sentence segmentation, tokenization (word segmentation), part-of-speech tagging, emotion classification, and topic extraction. In one embodiment, the server uses a separate transformer encoder model trained for sentiment or emotion analysis. The emotion analysis model receives tokenized text as input and outputs a vector of emotion scores (for example, joy, sadness, anger, fear, neutral). The server also uses a topic extraction component based on term frequency-inverse document frequency (TF-IDF) and clustering, or a probabilistic topic model such as latent Dirichlet allocation (LDA). These components operate on numerical vector representations of text constructed by word embeddings or subword embeddings.

The server maintains a data management device implemented as a relational database management system (DBMS) stored in the storage device. The server uses a database engine such as a relational database system, and stores structured data in relational tables. For example, the server defines:
a user table storing user identification information, profile information, and configuration settings;
a question table storing question identification information, question text, generation time, and linkage to user identification information when appropriate;
an answer table storing answer identification information, user identification information, question identification information, raw answer text, timestamps, and references to analysis results; and
an analysis table storing emotion scores, primary emotion labels, topic labels, and keyword lists for each answer.

The server also stores aggregated diary data in a diary table or a diary summary table, where each record corresponds to a diary entry or a summary for a day, week, or month. The tables are indexed by user identification information and timestamps to enable efficient retrieval of chronological data.

The server constructs user context data as a logical data structure that combines information from these tables. User context data may be implemented as an in-memory object or record that includes: a sequence of past question texts; corresponding answer texts; emotion labels and scores for each answer; topic labels; and aggregated statistics over recent time windows (for example, average joy score for the last seven days, most frequent topics in the last month). The server periodically synchronizes this in-memory structure with the database.

The server receives text data from the user via the terminal. The terminal is implemented as a user-operated computing device such as a smartphone, tablet, or personal computer, executing a client application or a web browser. The terminal displays question sentences received from the server, and provides an input field through a display user interface. The terminal uses an input subsystem such as a touch screen keyboard, a hardware keyboard, or a speech recognition interface to acquire user input. The terminal converts speech to text using a speech recognition engine provided by the terminal operating system when voice input is used.

The server provides an information input/output interface exposed as a network application programming interface (API) through the network interface. The terminal accesses this API using a communication protocol such as HTTPS. When the user inputs an answer to a question, the terminal sends text data including the answer text, the user identification information, and the question identification information to the server via the network interface. The server receives this data, validates the format, and stores it in the answer table of the database.

The server applies the NLP module to the answer text. The server first performs sentence segmentation and tokenization. The server assigns part-of-speech tags using a statistical or neural tagger. The server then applies the emotion estimation model. This model may be implemented as a transformer encoder with multiple layers, using self-attention mechanisms to compute contextualized token embeddings. The server aggregates the output embeddings, for example by average pooling over tokens or using a special classification token, and feeds this aggregated vector to a classification head consisting of one or more fully connected layers. The classification head outputs a probability distribution over a fixed set of emotion categories. The server selects the category with the highest probability as the primary emotion label and stores both the label and the probability vector in the analysis table.

The server performs topic extraction by computing TF-IDF vectors for the answer text, comparing them with previously learned topic centroids, or by inferring topic membership with a probabilistic model. The server identifies one or more topic labels (for example, “family,” “work,” “friends,” “health”) and stores these labels as part of the analysis result. The server may also extract keywords by selecting tokens with high TF-IDF scores or by using attention weights from a transformer-based model. The server stores these keywords in the analysis table to enable later queries and summaries.

The server then updates the user context data by adding the new answer, the associated analysis result, and updated aggregated statistics. Because the analysis results are stored in structured form, the server does not need to re-analyze the entire history when constructing context for the generative AI model. Instead, the server accesses indexed records from the database, computes summary statistics once per new answer, and stores them as part of the user context data. This reduces redundant computation and improves processing speed and scalability compared to systems that repeatedly pass long raw text histories to a model without structured summarization.

The server constructs a prompt sentence for the generative AI model. The server generates the prompt sentence as a concatenation of multiple components: a role description specifying the behavior of the generative AI model (for example, that it should act as a diary assistant), a recent context summary derived from the user context data, explicit emotion and topic information, and an instruction to output a single question. For example, the server may prepare a prompt sentence such as:

“You are a diary-assistant AI. You ask one concise, empathetic question at a time to help the user reflect on their day.

User's recent answer: ‘I had a great time having dinner with my family and talking about our plans.’
Detected emotion: joy
Detected topic: family, dinner, future plans

Task: Generate the next question as a single, friendly prompt sentence that encourages the user to reflect more on this experience.”

In another example, when the server wants to generate a broader reflection question, the server constructs a prompt sentence such as:

“You are a diary-assistant AI. You help the user look back on recent days.

Summary of this week: The user reported several joyful moments with friends and family, and some stress related to work deadlines.

Task: Generate one question that asks the user what they appreciate most about these experiences this week.”

By explicitly embedding structured context (emotion labels, topics, aggregated summaries) into the prompt sentence, the server controls the input feature space for the generative AI model and achieves more stable and reproducible behavior than simply passing arbitrary conversational text.

The server encodes the prompt sentence using a tokenizer associated with the generative AI model. The tokenizer maps each token (for example, a subword unit) to a numerical identifier. The server transfers the sequence of token identifiers to the GPU, and the GPU executes the forward pass of the generative AI model. The model manipulates internal state vectors through matrix multiplications, attention computations (query, key, value projections and attention weighting), and nonlinear activation functions. The server configures decoding parameters such as maximum output length, temperature, and top-k or top-p sampling thresholds, thereby enforcing additional control conditions on the output. In the claimed system, the server constrains the maximum number of generated tokens to correspond roughly to a single question sentence and stops generation when a sentence termination token is predicted.

Because the server uses structured user context data and control conditions in the prompt sentence, the generative AI model focuses on specific, machine-selected aspects of the user's history. This reduces the entropy of the output distribution and leads to more predictable, context-appropriate question sentences. From a technical perspective, this improves the accuracy of question relevance, reduces unnecessary token generation, and lowers the computational load on the GPU.

The server decodes the generated token identifiers to obtain a natural language question sentence, such as:

“What about having dinner with your family made you feel especially happy today?”

The server stores this question sentence in the question table together with user identification information, a new question identification information, and a timestamp. The server transmits the question sentence via the network interface to the terminal. The terminal receives the question sentence, updates the display user interface, and shows the question to the user in a conversational or diary-style layout.

The user reads the question on the terminal and inputs an answer such as: “I spent a really fun time with my friends at a café today. We talked for hours and laughed a lot.”

The terminal sends this answer to the server, and the cycle of analysis, context update, prompt sentence creation, and question generation continues. Over time, the diary data accumulates in the database, and the server uses this data to generate higher-level reflective questions. For example, when a daily reflection is requested, the server generates a prompt sentence like:

“Looking back on today, which moment stands out the most to you, and why?” When a weekly reflection is requested, the server generates a prompt sentence like: “Looking back over this week, what moment stands out the most to you, and what did you learn from it?”

These prompt sentences are constructed using aggregated emotion and topic distributions from the diary data, which the server computes by scanning records over a predetermined period and aggregating emotion scores and topic frequencies.

The server uses efficient database queries and precomputed aggregates to minimize latency. For example, the server may maintain a summary table that stores, for each user and each day, the average emotion score vector and the top-N topics. When computing weekly summaries, the server queries the summary table rather than re-scanning all individual answer records, which reduces I/O operations and CPU time. This design improves processing speed and reduces memory consumption compared to naive implementations.

In one embodiment, the server trains the generative AI model and the emotion classification model using supervised learning. The server uses a training dataset of input-output pairs stored in the storage device. During training, the server computes a loss function such as cross-entropy between predicted tokens and target tokens (for the generative model) or between predicted emotion labels and ground-truth labels (for the emotion classifier). The server performs backpropagation, computing gradients of the loss with respect to model parameters, and updates the parameters using an optimization algorithm such as stochastic gradient descent or adaptive gradient methods. The server may apply regularization techniques such as dropout or weight decay to prevent overfitting. For generative model fine-tuning, the server may use domain-specific conversational diary data, thereby tailoring the model's behavior to diary-style questions.

Because the server uses a neural network architecture and structured context, the decision-making behavior of the system differs from human manual questioning. The server selects follow-up topics by analyzing multi-dimensional emotion vectors, topic distributions, and temporal patterns, which a human typically does not quantify or compute systematically. The server also uses non-intuitive combinations of features, such as joint probability distributions over emotions and topics, to decide which aspects of the user's experience to probe. This non-conventional processing, combined with the use of transformer-based attention mechanisms, allows the system to capture long-range dependencies and subtle patterns across the user's diary history.

The server obtains technical effects not achievable by simple human automation. Because the server converts raw text into structured emotion and topic data, and uses this data to control model inputs and decoding, the system reduces redundant computations and stabilizes the behavior of the generative AI model. This leads to lower variance of output quality, reduced number of re-requests from the terminal, and improved consistency of generated questions. The server's use of pre-indexed user context data and aggregated diary summaries improves query performance and reduces memory bandwidth usage. As a result, the system can support more simultaneous users at lower hardware cost, and can provide responses with reduced latency.

In alternative embodiments, the server may use different model architectures. For example, the generative AI model may be implemented as an encoder-decoder transformer with separate encoder and decoder modules, or as a recurrent neural network with attention. The emotion analysis model may be implemented as a convolutional neural network or a recurrent network with gated recurrent units. The topic extraction component may be replaced or complemented by a clustering algorithm operating on sentence embeddings. The database may be implemented as a non-relational database or a hybrid system combining relational and key-value stores. The server may also use a caching layer to store frequently used user context data in a high-speed memory such as a memory-resident data structure store

The terminal may be implemented as a native application, a web application, or a hybrid application. In one embodiment, the terminal pre-processes user input (for example, basic tokenization or local language detection) to reduce the load on the server. In another embodiment, the terminal performs local encryption of user text before transmission, and the server performs decryption for analysis. These variations do not depart from the essence of using server-side NLP and generative AI model control based on structured user context data. The user uses the system as a diary tool without needing to understand the internal technical details. The user simply reads question sentences and provides answers through the terminal interface. The server, however, performs complex computational processes internally, including neural network inference, structured data management, and controlled prompt sentence construction. This architecture provides an improvement in computer technology by optimizing data flows, reducing redundant computations, and integrating specialized models for analysis and generation within a closed-loop control framework.

Thus, the described embodiments enable a server, a terminal, and a user to cooperate in constructing a context-aware, emotion-sensitive diary, while improving technical performance in terms of processing speed, accuracy of context adaptation, resource utilization, and stability of generative AI outputs.

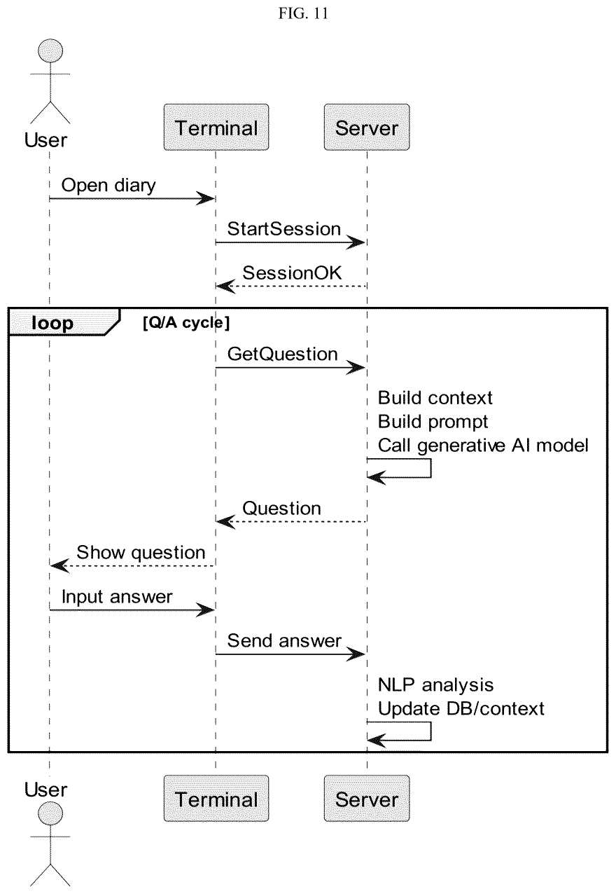

The following describes the processing flow using FIG. 11.

### Step 1:

Server initializes system components.

Server loads an operating system, a web application framework, a generative AI model, and a natural language processing (NLP) module into main memory.

Input: Configuration files specifying model paths, database connection parameters, and API endpoints.

Output: In-memory instances of the generative AI model, tokenizer, NLP models, and active database connections.

Server reads configuration data, opens the model files from storage, maps model weights into GPU memory, initializes the tokenizer, and establishes a connection pool to the database. Server also starts an HTTP or WebSocket server to accept requests from terminals.

### Step 2:

Terminal establishes a session with the server.

Terminal sends a request indicating that the user has opened the diary application or started a new session.

Input: User identification information, device information, and session start request from the user.

Output: A session token or session identifier received from the server and stored on the terminal.

Terminal constructs a request message including user ID and sends it via HTTPS. Terminal receives a response containing a session ID and stores it in local memory to attach to subsequent requests.

### Step 3:

Server prepares user context data for the session.

Server retrieves past answers, associated emotions, and topics from the database and constructs user context data.

Input: User identification information and session identifier from the terminal request.

Output: User context data including recent question-answer pairs, emotion history, and topic distributions.

Server issues SQL SELECT queries to the user, answer, analysis, and diary tables, orders records by timestamp, and aggregates emotion scores and topic counts over a specified period. Server converts the retrieved structured data into an in-memory context object.

### Step 4:

Server analyzes whether an initial question or a follow-up question is required.

Server checks the user context data to decide whether the user has already answered a question in the current session.

Input: User context data and session state.

Output: A control flag indicating “initial question” or “follow-up question.” Server evaluates conditions, such as whether there is any unanswered question in the database or whether the current session has a prior interaction, and sets the control flag accordingly.

### Step 5:

Server constructs a prompt sentence for the generative AI model.

Server composes a natural language prompt that includes a role description, user context summary, and generation constraints.

Input: User context data (recent answers, emotions, topics), control flag (initial or follow-up), and system-level rules for question generation.

Output: A formatted prompt sentence to be input to the generative AI model.

Server concatenates text segments: (i) instructions like “You are a diary-assistant AI . . . ”, (ii) selected recent answer texts, (iii) detected emotions and topics, and (iv) an explicit instruction to output a single question. Server may limit the number of past entries included by truncating text beyond a token limit.

### Step 6:

Server encodes the prompt sentence into model input tokens.

Server converts the prompt sentence into token identifiers usable by the generative AI model.

Input: Prompt sentence text.

Output: A sequence of token IDs and corresponding attention masks.

Server calls the tokenizer to split the prompt into subword units, maps each unit to an integer ID, and constructs an array of token IDs. Server also generates an attention mask array to distinguish valid tokens from padding tokens.

### Step 7:

Server generates a next question using the generative AI model.

Server performs inference on the generative AI model to generate a question sentence.

Input: Token ID sequence and attention masks representing the prompt sentence.

Output: Generated token ID sequence corresponding to a next question sentence.

Server sends the input tensors to the GPU, executes multiple transformer layers that compute self-attention and feedforward transformations, and applies a decoding algorithm (for example, greedy decoding or top-k sampling) with constraints on maximum length and termination. Server stops decoding when a sentence-ending token is produced or when the maximum number of tokens is reached.

### Step 8:

Server decodes generated tokens into a natural language question.

Server converts the output token IDs back into human-readable text.

Input: Generated token ID sequence from the generative AI model.

Output: A natural language next question sentence.

Server calls the tokenizer's decode function to map IDs to subword units and merges them into a string, handling spaces and punctuation. Server trims any extraneous tokens and ensures the result is a single interrogative sentence.

### Step 9:

Server records the generated question in the database.

Server stores the generated question together with metadata.

Input: Generated question sentence, user identification information, session identifier, and current timestamp.

Output: A new entry in the question table with question identification information and linkage to the user.

Server executes an SQL INSERT statement to store the question text, generates or retrieves a question ID (for example, via an auto-increment field), and associates it with the user ID and session ID. Server commits the transaction to ensure persistence.

### Step 10:

Server sends the generated question to the terminal.

Server transmits the question sentence and metadata to the terminal over the network.

Input: Generated question sentence and question identification information.

Output: An HTTP or WebSocket response containing the question sentence and question ID, delivered to the terminal.

Server formats a response object containing fields such as “questionText” and “questionId” and sends it via HTTPS. Server logs the outgoing message for diagnostic or audit purposes.

### Step 11:

Terminal displays the question to the user.

Terminal updates the user interface to present the new question.

Input: Question sentence and question identification information received from the server.

Output: A rendered question displayed on the screen and an active input field ready to receive an answer.

Terminal parses the response, extracts the question text, updates the display area (for example, a chat bubble or main question area), and clears or focuses the answer input field. Terminal may also scroll the view so that the newest question is visible.

### Step 12:

User reads the question and composes an answer.

User interprets the presented question and decides what content to provide.

Input: Visual or auditory representation of the question sentence on the terminal.

Output: A mental formulation of a response to the question.

User considers daily events and emotions relevant to the question, such as “What about having dinner with your family made you feel especially happy today?” and prepares textual content to input.

### Step 13:

User inputs the answer on the terminal.

User enters the response via typing or speech.

Input: User's intended answer content.

Output: Text data representing the user's answer on the terminal.

User types the answer using an on-screen or hardware keyboard or speaks into a microphone. Terminal converts speech to text if needed and displays the entered text in the input field for confirmation before sending.

### Step 14:

Terminal transmits the user's answer to the server.

Terminal sends the answer text and related metadata to the server via the network.

Input: Answer text, user identification information, question identification information, and session identifier.

Output: An HTTP or Web Socket request containing the answer data delivered to the server.

Terminal packages the answer into a request body, attaches authentication or session tokens, and sends the request using HTTPS. Terminal handles network errors by retrying or notifying the user if necessary.

### Step 15:

Server receives and validates the user's answer.

Server parses the incoming request and checks for consistency and completeness.

Input: Network request containing answer text, user ID, question ID, and session ID.

Output: A validated answer record ready for storage and analysis, or an error response if validation fails.

Server verifies that the user ID and question ID exist, that the answer text is not empty, and that the session ID matches an active session. If validation passes, server constructs an internal data object representing the answer.

### Step 16:

Server stores the answer in the database.

Server writes the answer record to the answer table.

Input: Validated answer data including answer text, user ID, question ID, and timestamp.

Output: A persistent answer record with a unique answer identification information.

Server executes an SQL INSERT statement to store the answer, obtains the generated answer ID, and commits the transaction. Server may also maintain indices on user ID and timestamp to enable efficient retrieval.

Step 17:

Server performs NLP analysis on the answer text.

Server processes the answer using the NLP module to derive structured analysis results.

Input: Answer text retrieved from the validated answer record.

Output: An analysis result including emotion scores, a primary emotion label, topic labels, and keywords.

Server tokenizes the text, applies part-of-speech tagging, and feeds the tokenized sequence into an emotion classification model. Server calculates a probability vector over emotion classes, selects the highest-probability class as the primary emotion, and computes additional metrics as needed. Server then computes TF-IDF or uses a topic model to identify dominant topics and extracts high-weight keywords.

### Step 18:

Server stores the analysis result in the database.

Server writes the structured analysis data to the analysis table and links it to the answer.

Input: Analysis result (emotion scores, primary emotion label, topics, keywords) and answer identification information.

Output: A persistent analysis record associated with the answer record.

Server executes SQL INSERT or UPDATE statements to save the analysis result, storing fields such as “emotion Vector,” “primaryEmotion,” “topics,” and “keywords,” and linking them via the answer ID. Server commits the transaction to ensure durability.

### Step 19:

Server updates user context data.

Server integrates the new answer and analysis result into the user's context structure.

Input: Newly stored answer record and associated analysis record, along with existing user context data.

Output: Updated user context data containing the latest answer, emotion, and topic information and updated summary statistics.

Server appends the new question-answer pair to the context sequence, updates rolling averages of emotion scores, recalculates topic frequency counts, and stores this updated structure in memory and/or a summary table for fast access.

### Step 20:

Server determines whether to generate the next question.

Server checks application logic and user interaction state to decide on further question generation.

Input: Updated user context data, session state, and configurable rules (for example, maximum number of questions per session).

Output: A decision flag indicating whether to generate another question or end the session.

Server evaluates conditions such as “has the maximum number of questions for this session been reached?” or “has the user requested to continue?” and sets the flag accordingly.

### Step 21:

Server generates a follow-up prompt sentence when another question is required. Server constructs a new prompt sentence emphasizing follow-up content based on recent context.

Input: Updated user context data including the latest answer, emotions, and topics, and a decision flag indicating that another question should be generated.

Output: A follow-up prompt sentence tailored to the latest emotional state and topics.

Server summarizes the latest answer (for example, “time with friends at a café” or “stress about work deadlines”), includes detected emotions (for example, joy or anxiety), and explicitly instructs the generative AI model to generate a question exploring those aspects further.

### Step 22:

Server repeats model encoding and generation for the follow-up question.

Server processes the new prompt sentence through the generative AI pipeline. Input: Follow-up prompt sentence.

Output: A new next question sentence suitable as a follow-up question.

Server encodes the prompt into tokens, runs inference on the generative AI model with specified decoding parameters, decodes the output tokens into text, and ensures that the result is a single question sentence.

### Step 23:

Server records and transmits the follow-up question.

Server logs the generated follow-up question in the database and sends it to the terminal.

Input: Generated follow-up question sentence, user identification information, and session identifier.

Output: A newly stored question record and a network response delivered to the terminal.

Server inserts the follow-up question into the question table and transmits it over the network as a response message, thus continuing the interactive diary session.

### Step 24:

Terminal displays the follow-up question and waits for the next answer.

Terminal presents the new question and prepares for further user input.

Input: Follow-up question sentence and question identification information from the server.

Output: Updated display showing the follow-up question and an active input control.

Terminal appends the follow-up question to the conversation view, scrolls to keep it visible, and resets the answer input field, thereby inviting the user to provide another answer and continuing the question-answer cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional diary and recommendation systems typically treat user input as static text and perform only shallow keyword extraction or rule-based sentiment scoring. As a result, such systems cannot flexibly adapt question generation or content recommendation to nuanced changes in a user's emotional state, evolving interests, and real-world context such as location and social activity. In many implementations, the server-side components merely store user entries and retrieve pre-defined questions or fixed recommendation templates, without dynamically leveraging large-scale generative AI models on the basis of rich, structured user context.

From a computer-technology perspective, this leads to several technical problems. First, server resources are not used to construct context-aware prompt sentences that efficiently condition a generative AI model on heterogeneous data (natural language diary text, emotion analysis results, external context data from location services and social networking services). The lack of structured prompt generation logic means that the generative AI model operates on incomplete or poorly organized input, yielding low-quality or generic output. Second, there is no integrated mechanism on the server to iteratively update prompts based on accumulated usage history and user feedback, which prevents the system from improving the relevance of generated questions and personalized information over time. Third, existing architectures do not tightly couple diary data management, emotion analysis, context acquisition, and generative AI invocation in a unified processing flow, so multiple disjoint modules must be orchestrated manually, increasing latency, processing overhead, and implementation complexity.

There is therefore a need for a computer-implemented technique in which a server-side processor systematically (i) acquires and stores user diary data and external contextual data, (ii) performs emotion and interest analysis on the aggregated data, (iii) constructs structured, context-rich prompt sentences for a generative AI model, and (iv) controls iterative regeneration of questions and personalized information in response to user feedback. By improving how the processor represents, combines, and feeds user context into a generative AI model, the underlying computer system can achieve more accurate, dynamically personalized interactive behavior and more efficient utilization of processing and network resources.

The specific processing by the specific processing unit 290 of the data processing device 12 in Application Example 1 is realized by the following means.

The present invention provides a server comprising a processor configured to provide a user interface for receiving natural language input from a user, to analyze the natural language input and past input stored in a storage device using natural language processing and emotion analysis to evaluate an emotional state and an interest profile of the user, to generate diary data as structured document data by associating the evaluated emotional state and interest profile with context data including position information and social network information acquired from an external information source, to record the diary data in the storage device, to construct a context-rich prompt sentence based on the diary data, the emotional state, the interest profile, and the context data so as to cause a generative AI model to generate a next dialog question and personalized information for the user, to supply the prompt sentence to the generative AI model and control reception of an output from the generative AI model, to obtain the next dialog question and the personalized information from the generative AI model, to store the personalized information in association with the diary data in the storage device, to transmit the next dialog question and the personalized information to a terminal device for presentation to the user, and to obtain additional input or detailed information requests from the user via the terminal device and update the prompt sentence based on a usage history including the additional input so as to instruct the generative AI model to execute a regeneration process using the updated prompt sentence. This enables the server to improve computer-implemented dialog and recommendation processing by dynamically generating and iteratively refining context-aware prompt sentences, thereby causing the generative AI model to produce questions and personalized information that are more accurately tailored to the user's emotional state, interests, and real-world context, while efficiently managing diary data and external context data within an integrated server-side architecture.

The term “system” refers to an arrangement of one or more computing devices, storage devices, communication interfaces, and associated software components that cooperate to execute the functions described herein.

The term “processor” refers to one or more hardware processing units, such as a central processing unit, a graphics processing unit, or a specialized accelerator, that executes instructions to perform operations including data acquisition, analysis, prompt construction, model invocation, and communication control.

The term “information processing apparatus” refers to a computing device or computing platform, such as a server device or cloud computing node, that hosts the processor and associated memory, storage, and communication interfaces used to implement the described functions.

The term “terminal device” refers to an endpoint device operated by a user, such as a mobile communication device, a tablet device, a portable information device, or a general-purpose computing device, that presents questions and personalized information to the user and acquires user input.

The term “user interface” refers to a combination of hardware and software elements, including display components, input components, and interface control logic, that enables a user to input natural language information and to receive questions and personalized information.

The term “natural language input” refers to text or speech content expressed in a human language that is provided by the user and processed by the system without requiring a predefined formal syntax.

The term “storage device” refers to a hardware memory or storage component, such as a magnetic storage device, a solid-state storage device, or a non-volatile memory device, that stores diary data, prompt sentences, model outputs, and usage history.

The term “natural language processing” refers to a set of computational techniques and algorithms for processing natural language data, including tokenization, part-of-speech tagging, syntactic analysis, semantic analysis, and text classification.

The term “emotion analysis” refers to computational processing that estimates or classifies a user's emotional state from natural language input or related data, for example by assigning sentiment labels or emotion categories based on linguistic features.

The term “emotional state” refers to an estimated psychological condition of a user, such as a positive, neutral, or negative sentiment or a more detailed emotional category, as determined by emotion analysis applied to user-related data.

The term “interest profile” refers to a representation of one or more topics, themes, or preferences inferred for a user from diary data, external context data, and usage history. The term “diary data” refers to structured or semi-structured document data representing user experiences, thoughts, or feelings over time, which is generated or updated from natural language input, emotion analysis results, and context data.

The term “document data” refers to data that expresses textual content in a structured or semi-structured format, such as a record comprising text fields, timestamps, and associated metadata.

The term “context data” refers to auxiliary information related to a user's situation or environment, including position information, social network information, time information, and other environmental attributes associated with user activities.

The term “position information” refers to data indicating a geographic location associated with a user, including coordinate information, region information, place names, or location-related metadata.

The term “social network information” refers to data obtained from a communication or social networking service, including text posts, reactions, tags, timestamps, and any metadata that represents user interactions or activities within such a service.

The term “external information source” refers to a system or service that is separate from the information processing apparatus and that provides context data, including but not limited to a location service, a map service, or a social networking service.

The term “prompt sentence” refers to a text sequence constructed by the processor that specifies input content and instructions for a generative AI model, and that conditions the model's output on diary data, emotion analysis results, and context data.

The term “generative AI model” refers to a machine learning model configured to generate natural language text or other content in response to input data, such as a neural network-based language model that produces questions or personalized information based on a prompt sentence.

The term “dialog question” refers to a natural language question generated or selected by the system for presentation to the user as part of an interactive, conversational process.

The term “personalized information” refers to content generated based on the emotional state, interest profile, diary data, and context data of a specific user, including recommendations, activity proposals, or reflective questions that are tailored to that user.

The term “usage history” refers to accumulated data representing past interactions between the user and the system, including past inputs, diary entries, model outputs, feedback, and any associated context or metadata.

The term “regeneration process” refers to a process in which a generative AI model is invoked with an updated prompt sentence that reflects additional input or refined context, so as to generate revised or additional questions or personalized information.

In one embodiment, a server cooperates with one or more terminals operated by a user to implement the claimed system. The server includes at least one processor, a main memory, a non-volatile storage device, and a network interface. The processor executes an application program that coordinates diary data management, natural language processing, emotion analysis, prompt sentence construction, and interaction with a generative AI model. The terminal includes a processor, a memory, a display device, one or more input devices such as a touch panel, and a wireless or wired communication interface.

The server uses a hardware platform such as a general-purpose server computer or a virtual machine instance provided by a cloud computing environment. The server runs an operating system such as a general-purpose server operating system. The server executes an application framework such as a web application framework implemented in a high-level language (for example, a framework conforming to HTTP-based REST interfaces). The server accesses a relational database management system such as a general-purpose SQL database (for example, a system similar to PostgreSQL or MySQL) to store diary data, context data, prompt sentences, model outputs, and usage history. The server further uses a logging system such as a general-purpose log database or search engine to record prompt sentences and responses.

The terminal uses a hardware platform such as a smart phone, a tablet device, or a personal computer. The terminal runs an operating system for mobile devices or desktop devices. The terminal executes a native application or a cross-platform application framework (for example, a framework similar to SwiftUI, Jetpack Compose, React Native, or Flutter). The terminal uses a JSON parsing library, a network library (for example, a library similar to URLSession or OkHttp), a UI library, a location service API, and APIs of social networking services.

The server stores, in the relational database, diary entries as structured records. Each diary record includes fields such as a user identifier, a timestamp, a text field for natural language diary content, an emotion state field, an interest profile field, a context identifier, and optional fields referencing external context records. The server stores, in separate tables, context data such as position information records and social network information records. A position information record contains, for example, a timestamp, latitude, longitude, an optional place name, and a foreign key to the corresponding diary entry or user identifier. A social network information record contains, for example, a timestamp, a text snippet, a set of tags or keywords, and a link to the user identifier and optionally to a diary entry.

The server uses natural language processing modules to process user input. In one embodiment, the server uses tokenization, sentence segmentation, part-of-speech tagging, dependency parsing, and named-entity recognition. The server implements these modules using a natural language processing library or a custom model. The server converts the natural language input into a sequence of tokens and into feature vectors. The server applies an emotion analysis model, such as a neural network classifier or a transformer-based classifier, to these feature vectors. The server maps an output probability distribution over predefined emotion categories (for example, positive, negative, neutral, joy, sadness, anger) into an emotion state stored in the diary record. The server also derives an interest profile from term frequencies, topic modeling (for example, Latent Dirichlet Allocation or neural topic models), or clustering of embedding vectors over multiple diary entries.

The server uses a generative AI model to generate dialog questions and personalized information. In one embodiment, the generative AI model is a transformer-based neural network configured as a large language model. The model uses multi-head self-attention layers, feedforward layers, positional encodings, and layer normalization. The model parameters include a plurality of weight matrices and bias vectors. The server stores, in memory or in a model repository, a configuration specifying the number of layers, the dimensionality of the hidden representations, the number of attention heads, and vocabulary size.

The server trains the generative AI model in advance using a corpus of text data. During training, the server minimizes a loss function such as cross entropy between predicted tokens and ground-truth tokens. The server updates model weights by an optimization algorithm such as stochastic gradient descent, Adam, or a variant thereof. The server may perform data augmentation such as synonym replacement, back-translation, or noise injection to improve robustness. The server stores the trained weights in a model storage unit, and loads them into memory at runtime. The server may also fine-tune the model on domain-specific conversation data or diary-like data, using a supervised fine-tuning process and optionally reinforcement learning from human feedback.

The server constructs a prompt sentence that encodes multiple types of information in a non-conventional, structured format that is optimized for the generative AI model. The server arranges diary text, emotion labels, interest tags, and context data into a textual template that distinguishes between system instructions, user content, and contextual metadata. For example, the server uses a template such as:

“System instruction: You are a reflective journaling assistant that generates questions and personalized content.
Diary entry: [diary_text]
Emotion: [emotion_label]
Interests: [interest_tags]
Context: [location_description]; [social_network_summary]

Task: Generate 2 open-ended questions to help the user reflect on today's experience and 3 personalized suggestions for activities related to the user's interests. Answer in English.”

The server uses this structured prompt sentence to reduce ambiguity for the generative AI model, thereby improving output quality and reducing the need for repeated calls. By embedding emotion and context information explicitly in the prompt sentence, the server reduces the amount of computation needed in subsequent rounds, because the model can rely on concise, precomputed context rather than re-inferencing it from large amounts of raw history.

The server sends the prompt sentence to the generative AI model through a model invocation interface. In one embodiment, the server calls a local model execution engine that uses a graphics processing unit or a tensor processing accelerator to perform matrix multiplications and attention computations. In another embodiment, the server calls a remote inference service through an API over a secure network. The server provides the prompt sentence as sequence input, and the model produces output tokens one by one, using a decoding algorithm such as greedy decoding, beam search, top-k sampling, or nucleus sampling. The server configures parameters such as temperature, top-k threshold, or top-p threshold based on the desired diversity and stability of results.

The server parses the model output, which may contain multiple questions and multiple recommendations. The server detects question boundaries using delimiters or numbering, and splits the output into discrete strings. The server identifies personalized information items such as recommendations or activity proposals by analyzing section labels or patterns in the output. The server stores each generated question and each piece of personalized information in the database, linked to the corresponding diary entry and usage session. This data-structure design enables efficient retrieval and reuse of past questions and answers, and supports future model retraining or evaluation.

The terminal displays questions and personalized information. The terminal receives data in a structured format, such as a JSON document containing fields for questions, personalized information items, and auxiliary metadata. The terminal parses the JSON and maps each field to UI components. The terminal uses resource-constrained layout and rendering techniques optimized for mobile displays, such as pre-rendering text layouts, reusing view holders, and limiting the number of visible items. By minimizing dynamic layout calculations, the terminal reduces CPU and GPU usage and improves responsiveness.

The terminal uses a location service API to acquire position information. The terminal requests coarse or fine location updates with specified intervals and accuracy thresholds to limit power consumption and communication overhead. The terminal, upon receiving location coordinates, uses a map or geocoding service to resolve the coordinates into a human-readable place name. The terminal sends the processed position information to the server, instead of raw high-frequency sensor data, thereby reducing communication load and server-side processing burden.

The terminal accesses social network information through application programming interfaces of external services. The terminal obtains user consent and obtains an access token according to an authorization protocol. The terminal then requests recent posts, reactions, or check-ins. The terminal summarizes the data locally, for example by extracting text captions and computing token frequencies, and only sends a compact representation to the server (such as top keywords, counts, and a short text snippet). This selective transmission reduces network traffic and protects user privacy.

The user interacts with the system through the terminal. The user reads the dialog questions shown on the display, and provides natural language answers through the input interface. The user may also review personalized information such as recommended activities and reflection questions. The user can provide feedback, such as preferences for content types or follow-up questions, using specific UI elements like buttons or free-text input fields. The terminal forwards this feedback to the server, where it is stored in a usage history table.

The server updates the prompt sentence based on usage history. The server computes statistics from previous interactions, such as the frequency of accepted recommendations, skipped items, or specific content categories. The server updates a user preference vector that encodes, for example, preference weights for categories such as indoor activities, outdoor activities, reading, audiovisual media, or social activities. The server embeds this vector in the prompt sentence as textual annotations, for example:

“User preferences: prefers books over movies; prefers outdoor activities on weekends.”

By including this structured preference information in the prompt sentence, the server causes the generative AI model to generate content aligned with long-term user patterns. This mechanism goes beyond simple rule-based filtering, because the preference vector is computed by analyzing historical interactions at the server side using statistical and machine learning techniques.

The server, by integrating diary analysis, context acquisition, and generative AI invocation into a single orchestrated pipeline, improves computer technology in several ways. First, computing resources are allocated more efficiently because the server precomputes emotion labels, interest profiles, and context summaries, and uses them as condensed features in prompt sentences. This reduces the amount of raw data that must be transmitted to and processed by the generative AI model, which shortens inference time and reduces bandwidth consumption. Second, the server constructs prompt sentences with a fixed structure that aligns with the generative AI model's internal representation, which improves the consistency and accuracy of the model's outputs. This reduces the number of retries and corrections needed, thus reducing total computation and latency. Third, the server maintains diary data and context data in normalized relational tables with explicit foreign keys and indexed fields. This design allows the server to execute optimized queries to retrieve only relevant records, reducing I/O operations and improving throughput when multiple users are served concurrently.

In one variation, the server uses a two-stage model architecture. The server first uses a smaller, specialized classifier to determine whether new input warrants deep generative processing. If the classifier determines that simple rule-based responses or cached answers suffice, the server avoids invoking the large generative AI model. This conditional invocation reduces computational load on the hardware accelerator and improves processing speed. Only when the classifier detects that a new situation or complex emotional state is present does the server construct a full context-rich prompt sentence and invoke the generative AI model. This architecture yields a technical effect of reducing average response time and energy consumption.

In another variation, the server uses different prompt sentence templates for different device conditions or network conditions. For example, when the terminal reports a low-bandwidth network or low battery state, the server constructs a shorter prompt sentence that omits certain non-critical context components. The server thereby reduces the size of the data transmitted to and from the generative AI model and reduces the size of responses. This conditional prompt adaptation results in lower communication load and faster responses under constrained conditions.

In another embodiment, the server logs detailed intermediate results of emotion analysis and interest extraction, such as embedding vectors computed for each diary entry. The server stores these vectors in a vector index, which supports nearest-neighbor search. The server, when building prompt sentences, retrieves only the top-k most similar past entries using efficient approximate nearest-neighbor algorithms, instead of scanning all past diary entries. This design improves scalability as the number of stored diary entries grows, because it bounds the cost of context retrieval.

The server also configures the generative AI model with particular decoding parameters to reduce hallucination and improve stability. For example, the server sets a low temperature and a constrained vocabulary for emotion labels and content categories, ensuring that the model uses predefined, technically meaningful labels that correspond to fields in the database. By constraining output in this way, the server can reliably parse the model's responses into database fields without complex error handling, which improves robustness and reduces parsing overhead.

The server causes the generative AI model to operate under rules that are different from conventional human manual procedures. Instead of relying on heuristic human rules for question generation, the server encodes machine-interpretable control instructions in the prompt sentence, such as explicit separators, section titles, and output format constraints. The generative AI model follows these structured constraints during decoding, thereby generating outputs that are directly consumable by downstream parsing routines. This non-conventional control method enables automated, high-speed generation and consumption of content, which is not achievable by manual human workflows.

In a specific example, the server constructs a prompt sentence as follows: “System instruction: You are a personal content recommendation assistant.

Diary entries: ‘Today I went to a café with my friends and had a great time.’, ‘Yesterday I relaxed at home watching movies about friendships.’

External context: the user frequently visits cafés on weekends and posts café photos with friends.

Task: Analyze the diary entries and external context, then generate:
(1) a short summary of the user's current mood,
(2) 3 personalized recommendations for movies, books, or activities related to cafés and friendships, and
(3) 1 reflection question that helps the user think more deeply about their relationships.

Output in English in the following structure:
Mood summary: . . .
Recommendations:
1. . . .
2. . . .
3. . . .
Reflection question: . . . ”

The server sends this prompt sentence to the generative AI model, receives the structured textual output, and parses each line into internal fields. The server records the mood summary and each recommendation in the database with their own identifiers, timestamps, and relation to the source diary entries. The server then sends these items to the terminal for display.

In another specific example, the server refines recommendations using a prompt sentence such as:

“The user previously received these recommendations: ‘Watch a movie set in a cozy café’, ‘Try a new café with friends’.

The user's feedback is: ‘I prefer books over movies, and I'd like some outdoor activities.’

Based on the user's diary entries about cafés and friendships and this feedback, generate 4 new recommendations focusing on books and outdoor activities. For each recommendation, provide a title and a 1-2 sentence explanation of why it matches the user's interests.
Output as:
1. Title: . . .
Reason:
2. Title: . . .
Reason: . . .
3. Title: . . .
Reason:
4. Title: . . .
Reason: . . . ”

The server, by using such detailed, structured prompt sentences, achieves technical benefits including improved output predictability, reduced need for post-processing, and lower overall computation and latency. The system as a whole thereby improves computer-implemented dialog and recommendation processing, rather than merely automating human mental steps.

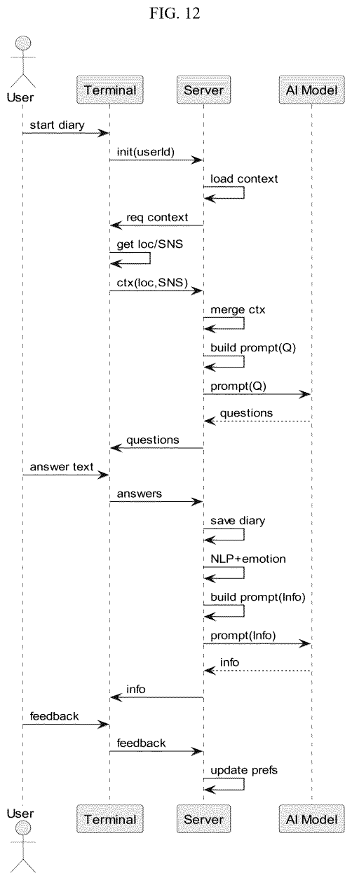

The following describes the processing flow using FIG. 12.

### Step 1:

The terminal initializes an interaction session.

The terminal receives a session start command from the user, for example when the user launches an application or selects a “Start diary” function. The input is a user action event (such as a tap on a UI element) and a user identifier stored on the terminal. The terminal loads locally stored configuration data, including display preferences, language settings, and cached authentication tokens. The terminal packages the user identifier and device status information (for example, OS version, network connectivity) into a request and transmits it to the server over a secure network connection. The output of this step is an initialization request message sent from the terminal to the server.

### Step 2:

The server prepares user context and retrieves historical data.

The server receives the initialization request. The input is the request containing the user identifier and device status information. The server uses the user identifier to query a relational database, executing selection operations to retrieve recent diary entries, emotion states, interest profiles, and context records linked to the user. The server also retrieves usage history statistics, such as which recommendations were accepted or ignored. The server aggregates this data into an in-memory context object, performing data operations such as sorting by timestamp, limiting the number of entries, and normalizing text encodings. The output of this step is a structured internal context object representing the user's recent behavior and state.

### Step 3:

The server computes emotion and interest features from the historical data.

The server takes the context object as input, including diary texts and metadata. The server applies natural language processing operations: tokenization, sentence segmentation, and embedding generation using a text encoder. The server feeds the embeddings into an emotion analysis model, which may be a neural network classifier. The server executes matrix multiplications and activation functions to compute probability distributions over emotion categories. The server selects the top category or a weighted combination and stores them as emotion features. The server also computes an interest profile by aggregating topic scores or term frequencies across diary entries. The output of this step is an updated context object containing explicit emotion features and interest features.

Step 4: The server acquires external context from the terminal.

The server sends a request to the terminal for current context. The input is the user identifier and a context request specification identifying required data types such as position information and social network information. The terminal receives this request, calls device APIs for location services to obtain coordinates, and calls social networking service APIs to retrieve recent user activity. The terminal locally filters and summarizes the external data (for example by selecting the last N posts, extracting captions, and counting tags). The terminal transmits a compact context summary and associated metadata back to the server. The output of this step is an external context message containing position information and summarized social network information.

### Step 5:

The server integrates external context with internal context.

The server receives the external context message. The input is the compact context summary with location coordinates, place names, and social network snippets. The server writes new records into context tables with fields such as timestamp, location, tags, and links to the user identifier. The server associates these records with existing diary entries if timestamps are close. The server updates the in-memory context object by attaching location descriptions and social network summaries to the corresponding time periods. The server may perform operations such as clustering or scoring to determine which context items are most relevant to the current session. The output of this step is a fully enriched context object combining diary history, emotion features, interest features, and external context.

### Step 6:

The server constructs a prompt sentence for generating the next dialog question.

The server takes the enriched context object as input. The server selects the most recent diary entry or, if none exists for the current day, constructs a brief summary from external context alone. The server formats this information into a structured text template, including system instructions, recent diary excerpts, emotion labels, interest keywords, and context descriptions. The server performs string concatenation operations and template filling, ensuring that special markers and line breaks are correctly inserted. The resulting text is a prompt sentence designed for the generative AI model, such as:

“System instruction: You are a reflective journaling assistant.

Recent diary entries: ‘I was busy with work but enjoyed coffee breaks with colleagues.’

Emotion: positive, slightly tired.

Interests: coffee, socializing, relaxing.

Context: user visited a café after work today and posted a picture with colleagues.

Task: Generate 2 open-ended questions to help the user reflect on today's experiences and emotions. Answer only with the questions in English.”

The output of this step is a finalized prompt sentence stored as a text object.

### Step 7:

The server invokes the generative AI model to generate dialog questions.

The server uses the prompt sentence as input to the generative AI model. The server tokenizes the prompt sentence into token identifiers using a tokenizer corresponding to the model's vocabulary. The server sends the token sequence to a model execution engine, which may run on a graphics processing unit or specialized accelerator. The model performs internal computations, including multi-head self-attention, feedforward transformations, and layer normalization, to generate probability distributions over the vocabulary for each next token. The server uses a decoding algorithm, such as greedy decoding or beam search, to select output tokens and assembles them into text questions. The server receives the generated text, then performs parsing and cleanup (for example, removing extraneous leading labels or trimming whitespace). The output of this step is a list of one or more dialog questions in natural language.

### Step 8:

The server stores generated questions and sends them to the terminal.

The server uses the list of questions as input. The server inserts new records into a questions table, each record containing the question text, a timestamp, the associated user identifier, and a link to the context used to generate it. The server assigns unique identifiers to each question. The server then constructs a response message containing the questions and their identifiers, encoded as a structured object. The server transmits this message to the terminal via a network interface. The output of this step is a question response sent to the terminal.

### Step 9:

The terminal presents the dialog questions to the user.

The terminal receives the question response message. The input is one or more question texts with identifiers. The terminal parses the message and maps each question to a display component. The terminal uses UI layout logic to create text views, apply fonts and styles, and arrange them on the screen. The terminal may register event handlers for input fields associated with each question. The terminal then renders the UI on the display, so that the user sees the questions. The output of this step is a rendered question screen visible to the user.

### Step 10:

The user provides natural language answers.

The user views the questions on the terminal. The input is the displayed question text. The user thinks about daily experiences and types responses into the text input fields using the on-screen keyboard. The user may edit the text, insert additional details, or delete parts until satisfied. The user then triggers submission of the answers, for example by pressing a “Submit” button. The output of this step is a set of answer texts associated with particular question identifiers, held in the terminal's memory.

### Step 11:

The terminal packages and transmits the user's answers.

The terminal uses the answer texts and the corresponding question identifiers as input. The terminal reads the current timestamp from the system clock and, optionally, obtains updated position information. The terminal validates the input (for example, ensuring that each required field is not empty) and removes leading and trailing whitespace. The terminal constructs a structured message containing the user identifier, question identifiers, answer texts, timestamps, and context metadata. The terminal sends this message to the server over a secure network channel. The output of this step is an answer submission message delivered to the server.

### Step 12:

The server records the answers as diary data.

The server receives the answer submission message. The input is a set of answers, each linked to a question identifier and user identifier. The server normalizes the text by standardizing line breaks and character encodings. The server then creates new diary records, each containing the answer text, a timestamp, a link to the originating question, and a link to the user. The server inserts these records into the diary table using database operations. The server may also create or update an aggregated diary entry for the day by concatenating multiple answers. The output of this step is stored diary data representing the user's new input.

### Step 13:

The server performs emotion analysis and interest extraction on the new diary data.

The server takes the newly stored diary texts as input. The server runs a natural language processing pipeline: tokenization, embedding generation, and feature extraction. The server feeds the embeddings into an emotion classifier to compute probabilities for each emotion category. The server then selects one or more categories as the emotion state and writes them into the diary records. The server updates the interest profile by re-calculating topic scores or keyword frequencies, possibly using a rolling window over recent entries. The output of this step is updated diary data enriched with new emotion states and interest features.

### Step 14:

The server constructs a prompt sentence for generating personalized information. The server uses the enriched diary data, emotion states, interest profile, and external context as input. The server selects representative diary excerpts and summarizes external context by applying text summarization techniques, such as sentence ranking or simple truncation based on length. The server formats this data into a prompt sentence template that requests personalized recommendations and reflection questions. For example, the server may construct:

“You are a personal content recommendation assistant.

Diary entries: ‘Today I went to a café with my friends and had a great time.’, ‘Yesterday I relaxed at home watching movies about friendships.’

External context: the user frequently visits cafés on weekends and posts café photos with friends.

Task: Analyze the diary entries and external context, then generate:
(1) a short summary of the user's current mood,
(2) 3 personalized recommendations for movies, books, or activities related to cafés and friendships, and
(3) 1 reflection question that helps the user think more deeply about their relationships.

Answer in English.”

The output of this step is a prompt sentence specifically aimed at generating personalized information.

### Step 15:

The server invokes the generative AI model to generate personalized information.

The server takes the personalized-information prompt sentence as input. The server tokenizes the prompt, feeds the token sequence into the generative AI model, and executes inference. The model computes attention weights and updates hidden states across its layers, and then outputs tokens representing a mood summary, recommendations, and a reflection question. The server decodes the tokens into text and may post-process the text to separate the different requested components, using pattern matching or line-based splitting. The output of this step is a set of personalized information items: a mood summary, multiple recommendations, and at least one reflection question.

### Step 16:

The server stores personalized information and prepares content for delivery. The server uses the mood summary, recommendations, and reflection question as input. The server creates records in a personalized information table, with fields for type (mood summary, recommendation, reflection question), content text, creation time, and links to the associated diary entries and user identifier. The server may assign categories or tags to each recommendation based on keywords. The server then constructs a response message containing all personalized items and necessary metadata. The output of this step is a personalized information response message sent toward the terminal.

### Step 17:

The terminal displays personalized information and accepts feedback.

The terminal receives the personalized information response. The input is a structured message containing the mood summary, recommendations, and reflection question. The terminal parses the message, creates UI components (for example, cards or list items), and renders the mood summary at the top, followed by recommendations and the reflection question. The terminal also displays feedback controls, such as buttons labeled “Like”, “Not interested”, or “More like this.” When the user interacts with these controls, the terminal records corresponding feedback events with references to the specific items. The output of this step is a visual presentation of personalized information and a set of potential feedback events captured locally.

### Step 18:

The user reviews the personalized information and provides feedback or further requests.

The user reads the mood summary and evaluates whether it matches the current feelings. The user reviews each recommendation and decides whether it is appealing or irrelevant. The user may tap on feedback buttons or enter text feedback, such as “I prefer books over movies” or “Suggest more outdoor activities.” The user may also select the reflection question and type an additional, deeper answer. The output of this step is a collection of feedback data and possibly new natural language input stored temporarily in the terminal.

### Step 19:

The terminal transmits feedback and additional input to the server.

The terminal uses the feedback data and any new natural language answers as input. The terminal attaches identifiers of the related personalized information items and the user identifier. The terminal validates the data and, if necessary, compresses or encodes it. The terminal sends a feedback message to the server over the network. The output of this step is a feedback submission that reaches the server.

### Step 20:

The server updates usage history and refines future prompt sentences.

The server receives the feedback submission. The input is a set of feedback events and optional additional natural language text. The server writes new records into a usage history table, indicating which items were liked or disliked. The server recalculates preference weights for content categories, adjusting parameters in the user's interest profile. The server then updates the logic that constructs future prompt sentences, for example by inserting textual annotations such as “User prefers books over movies and enjoys outdoor activities on weekends.” The server stores these updated preference descriptors and uses them in subsequent prompt construction steps. The output of this step is an updated user model and refined prompt generation parameters, which will guide later invocations of the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented journaling and diary systems typically rely on the user to manually enter content and select topics, with the computing device serving only as a passive storage and display platform. Even when such systems integrate natural language processing to analyze user input, they often operate only on narrowly scoped, single-session text and do not systematically utilize heterogeneous activity information such as posting information, image information, and location information that are distributed over multiple external services. As a result, the computer does not effectively transform this diverse activity information into structured behavioral feature data, and does not leverage such data to dynamically control a generative AI model in a technically efficient and context-aware manner.

Further, in many existing systems, the generation of questions for self-reflection is implemented as a static or rule-based process. The computer typically uses pre-defined question templates that are weakly linked to the user's actual behavior, and the processing unit does not construct prompt sentences that precisely encode, in natural language, multi-dimensional behavioral context such as time information, location information, behavior type information, and emotional tendency information. Consequently, the generative AI model is not provided with sufficiently constrained and structured input, which leads to generic, low-relevance questions and inefficient use of computational resources for generative processing.

Additionally, existing systems often treat user answers merely as unstructured diary text. They fail to systematically associate answer information with the underlying activity information and behavior analysis results within a unified data model. This lack of structured association prevents the computer system from performing efficient, indexed retrieval of past records by time-series or by behavior unit, and limits the system's ability to adaptively refine future prompt sentences and question generation based on accumulated behavioral and emotional histories.

In this context, there is a need for an improved computer-implemented system that technically enhances the way a processor acquires and preprocesses heterogeneous activity information, normalizes it into behavioral feature data including emotional tendency information, constructs structured prompt sentences for a generative AI model, and stores user answer information in a manner that is tightly linked to the underlying analysis results. Such a system should improve the functioning of the computer itself by providing a specific data processing architecture and control flow that enables the processor to generate more contextually relevant introspective questions with reduced manual configuration, and to manage diary information in an efficiently searchable and machine-usable form.

The specific processing by the specific processing unit 290 of the data processing device 12 in Example 2 is realized by the following means.

The present invention provides a server comprising a processor configured to acquire, via a communication network, activity information of a user including behavior-related information such as posting information, image information, and location information from one or more external information processing apparatuses or external information providing apparatuses, and to store the acquired activity information in a storage device; to preprocess the activity information by executing a data analysis program so as to normalize the activity information into behavioral feature data including time information, location information, behavior type information, and emotional tendency information, and to store an analysis result of behavior based on the behavioral feature data; to generate, on the basis of the analysis result of behavior and the activity information, a prompt sentence described in natural language including contextual information regarding a date and time of behavior of the user, a place of the behavior, contents of the behavior, and an emotional tendency, to input the prompt sentence to a generative AI model, and to thereby cause the generative AI model to generate one or more introspective questions to be presented to the user; to transmit, via the communication network, the questions generated by the generative AI model and image information or location information associated with the questions to a terminal device, and to cause the terminal device to display the questions; to receive, from the terminal device, answer information input by the user in response to the questions, and to store the answer information in the storage device as record information in association with the activity information and the analysis result of behavior; and to generate display data for searching and presenting the record information in a time-series manner or on a per-behavior basis. This enables the computer system to technically improve the processing of heterogeneous user activity information by transforming it into structured behavioral feature data, to control a generative AI model through context-rich prompt sentences that are automatically synthesized from the analysis result of behavior, and to maintain diary information in a linked, machine-usable format that supports efficient retrieval and adaptive refinement of subsequent question generation.

The term “system” refers to a combination of hardware and software components, including at least one processor, memory, storage, and communication interfaces, that cooperatively execute programmed instructions to perform the claimed functions.

The term “processor” refers to one or more processing units, such as a central processing unit or a processing core, that execute computer-readable instructions to perform data processing, control, and communication operations according to the claimed configuration.

The term “server” refers to a computing apparatus including the processor, memory, storage, and network interfaces, which is configured to provide data processing and communication services to one or more remote devices via a communication network.

The term “terminal device” refers to a user-operated computing apparatus, such as a handheld device, a portable device, or a fixed terminal, that includes an input unit and a display unit and that communicates with the server via a communication network.

The term “user” refers to a human operator who interacts with the terminal device and the system by providing activity information, viewing generated questions, and inputting answer information.

The term “communication network” refers to a wired or wireless data communication infrastructure, such as a local area network, a wide area network, or a public network, through which data is transmitted between the server, external apparatuses, and the terminal device.

The term “storage device” refers to one or more computer-readable storage media, such as a magnetic storage medium, an optical storage medium, or a semiconductor memory, configured to non-transitorily store data, programs, activity information, analysis results, and record information.

The term “activity information” refers to digital data representing behavior-related information of the user, including at least posting information, image information, and location information, which is obtainable from one or more external information processing apparatuses or external information providing apparatuses.

The term “behavior-related information” refers to information that characterizes actions, events, or situations associated with the user, including textual posts, media data, and positional data that can be used to infer the user's activities.

The term “posting information” refers to text data or metadata that represents user-generated content submitted to a communication service or information service, such as captions, comments, messages, or associated timestamps.

The term “image information” refers to digital image data or metadata related to images associated with the user's activities, including, for example, photographs, thumbnails, image identifiers, and acquisition times.

The term “location information” refers to data indicating a geographical position related to the user's activities, including coordinate information, region information, place names, or other positional identifiers.

The term “external information processing apparatus” refers to a computing apparatus, other than the server and the terminal device, that processes and provides activity information via a communication service or application programming interface.

The term “external information providing apparatus” refers to an apparatus or system that supplies activity information, such as posting information, image information, or location information, to the server via an electronic interface.

The term “data analysis program” refers to a set of computer-executable instructions that, when executed by the processor, preprocess, normalize, and analyze activity information to derive behavioral feature data and analysis results of behavior.

The term “behavioral feature data” refers to structured data derived from activity information, including at least time information, location information, behavior type information, and emotional tendency information, which collectively describe characteristics of user behavior.

The term “time information” refers to data representing temporal attributes of user activities, such as dates, times, or time segments associated with the activity information.

The term “location information” (as used within behavioral feature data) refers to normalized positional data representing a place associated with a user activity, such as coordinates, place names, or categorized location identifiers.

The term “behavior type information” refers to data indicating a classification or category of a user activity, such as taking an image, posting a message, visiting a place, or performing another predefined behavior.

The term “emotional tendency information” refers to data representing an inferred emotional state or sentiment related to a user activity, such as positive, negative, or neutral inclination, or more detailed emotional categories, obtained through analysis of activity information.

The term “analysis result of behavior” refers to data representing processed and interpreted outcomes derived from behavioral feature data, indicating patterns, tendencies, or contextual understanding of the user's behavior.

The term “prompt sentence” refers to a natural-language text string generated by the processor, which describes contextual information including at least a date and time of behavior, a place of the behavior, contents of the behavior, and an emotional tendency, and which is used as input to a generative AI model.

The term “generative AI model” refers to a machine learning model, such as a language model, configured to generate natural-language text in response to an input text, including the generated prompt sentence, according to learned statistical or neural representations.

The term “introspective questions” refers to natural-language questions generated by the generative AI model based on the prompt sentence, which are designed to cause the user to reflect on internal states, feelings, or thoughts related to the user's activities.

The term “contextual information” refers to descriptive data included in the prompt sentence that specifies circumstances of a user activity, such as the date and time, the place, the behavior content, and the associated emotional tendency.

The term “text data” refers to character-based digital information, including words, phrases, and sentences, that represents elements of activity information or analysis results in a language-readable form.

The term “predetermined template” refers to a predefined text structure or format that specifies positions or placeholders for inserting time information, location information, behavior content information, emotional tendency information, or other elements into a prompt sentence.

The term “open-ended questions” refers to questions that are not restricted to yes/no or fixed-choice answers and that invite the user to provide free-form, descriptive, or narrative responses.

The term “internal state of the user” refers to mental, emotional, or reflective conditions or processes of the user that may be elicited or expressed in response to the introspective questions.

The term “answer information” refers to text data or other user-generated content that the user inputs via the terminal device in response to one or more introspective questions.

The term “record information” refers to data stored in association with activity information and analysis results of behavior, including at least answer information, that forms a persistent record of user responses and related context.

The term “display data” refers to data structures or formatted information generated by the processor for presentation on a display device, enabling searching, listing, or visualizing record information in one or more formats.

The term “time-series manner” refers to an arrangement or presentation of record information according to chronological order, such as by date or time of the underlying activity or answer.

The term “per-behavior basis” refers to an arrangement or presentation of record information grouped or indexed according to individual user behaviors or activity units.

The term “diary information” refers to record information stored for each question as answer information associated with activity information and analysis results of behavior, which collectively functions as a computer-implemented diary.

The term “list format” refers to a display format in which diary information or record information is presented as a sequence of items, such as entries ordered by time or category. The term “calendar format” refers to a display format in which diary information or record information is arranged and presented according to a calendar structure, such as by days, weeks, or months.

In one embodiment, a server provides a concrete hardware and software platform for implementing the claimed system. The server includes at least one processor, a main memory, a non-transitory storage device, and a network interface. The server uses, for example, a multi-core central processing unit and may further include one or more graphics processing units for accelerating machine learning inference. The server executes an operating system such as a general-purpose server operating system and runs application software including a web server module, an application logic module, a data analysis module, and an AI inference client module. The server is connected via a communication network to one or more terminal devices and one or more external information processing apparatuses or external information providing apparatuses.

The server acquires activity information of a user from the external information processing apparatuses or external information providing apparatuses. The server uses, for example, an application programming interface provided by a communication service to receive posting information, image information, and location information. The server uses an HTTP client library to transmit authenticated requests over a transport protocol, receives responses in a structured data format, and parses the responses into internal data structures stored in the storage device. The server represents each activity item by a unique activity identifier and stores associated fields such as timestamp, raw text, image identifier, image metadata, and geographic coordinates in relational tables and index structures.

The server preprocesses and normalizes the activity information into behavioral feature data. The server uses, for instance, a data analysis library to load records from the storage device into an in-memory tabular structure. The server converts timestamps into a unified time zone and derives additional temporal features such as day-of-week and time-of-day category. The server converts raw geographic coordinates into normalized location information, for example by calling a geocoding service to obtain place categories. The server classifies behavior type information by analyzing metadata fields, such as distinguishing between posting an image, posting text only, or visiting a place, according to predefined rules implemented in the data analysis module.

The server derives emotional tendency information from the posting information and related context. The server uses a natural language processing pipeline that includes tokenization, normalization, and embedding generation. In one embodiment, the server applies a sentiment analysis model implemented as a neural network. The neural network is, for example, a transformer-based architecture including an embedding layer, multiple self-attention layers, and a classification head. The server feeds tokenized and embedded text into the model and obtains an output vector representing probabilities over sentiment categories. The server interprets this output vector as an emotional tendency score, such as positive, negative, or neutral, optionally with intensity values. The server stores the emotional tendency information as part of the behavioral feature data associated with the corresponding activity identifier.

The server uses a specific data structure to store behavioral feature data. For each activity identifier, the server maintains a feature record containing key-value pairs for time information, location information, behavior type information, and emotional tendency information. The server indexes these feature records by user identifier and time to enable efficient retrieval. This structured representation reduces the computational cost of subsequent queries compared to scanning raw, heterogeneous activity logs, thereby improving processing speed and lowering memory usage.

The server generates a prompt sentence for a generative AI model based on the behavioral feature data and the underlying activity information. The server uses a template-based prompt construction module that combines multiple fields into a coherent natural language description. The server selects fields such as date, location, behavior type, brief description of the image or post, and emotional tendency, and places these fields into placeholders within a predetermined template. For example, the server may generate a prompt sentence as follows:

“Generate 3 reflective questions about the following activity.
Date: 2023 Oct. 5
Location: Tokyo, Japan
Activity description: The user took a photo of a city skyline at sunset with orange and pink colors.
User's original comment: ‘Beautiful sunset today!’
Detected sentiment: positive, calm Focus on the user's feelings, thoughts, and personal meaning behind this moment. Output the questions in English, each on a separate line.” In another example, the server may generate a prompt sentence such as:

“Please act as a journaling coach. Based on this activity, generate 5 questions that help the user reflect:
Date: 2023 Oct. 5
Location: Shinjuku, Tokyo
Activity: The user visited a new café with friends and posted a smiling group photo on social media.
Detected sentiment: joyful, socially connected

Ask about emotions, relationships, and what the user learned. Output concise, open-ended questions in English.”

The server constructs these prompt sentences in a non-conventional manner by explicitly encoding multi-dimensional behavioral context and emotional tendency into the input of the generative AI model. This differs from simple manual question creation or generic prompting, and causes the generative AI model to operate on a structured abstraction of the user's behavior, thereby improving the relevance and consistency of generated questions. The structured, feature-based prompt construction also reduces the variability in model inputs, which contributes to more stable and predictable model outputs and reduced need for manual post-processing.

The server uses a generative AI model to generate introspective questions from the prompt sentence. In one embodiment, the generative AI model is a transformer-based language model with an encoder-decoder or decoder-only architecture, trained on large-scale natural language corpora. The model comprises multiple layers of self-attention, feed-forward networks, and layer normalization. The server configures the model with specific hyperparameters such as number of layers, hidden dimension size, number of attention heads, and dropout rate. During inference, the server encodes the prompt sentence into token sequences and feeds these tokens into the model. The model produces output token probabilities, and the server decodes these probabilities into question text by using a decoding algorithm such as greedy decoding or beam search. The server controls decoding parameters including temperature and maximum output length to balance diversity and coherence of the questions.

The server may use a trained model that has been fine-tuned on a question-generation dataset, including pairs of activity-like descriptions and human-authored reflective questions. During training, the server or another training apparatus minimizes a loss function such as cross-entropy between predicted tokens and ground-truth tokens. The training process updates model parameters using an optimization algorithm such as stochastic gradient descent or an adaptive optimizer. The server may further employ data augmentation techniques, such as paraphrasing activity descriptions or varying emotional context phrases, to improve model robustness. These training and fine-tuning details ensure that the generative AI model is specifically adapted to generating introspective questions from behavior context, which is a technical configuration beyond a generic, off-the-shelf language model.

The server performs prompt construction and model invocation according to predefined rules and non-conventional sequencing. For example, the server applies rule-based filters to the behavioral feature data to decide which activities are suitable for question generation, such as excluding activities with incomplete time or location fields or low-confidence emotional tendency scores. The server may compute a relevance score for each activity using a deterministic function that combines recency, emotional intensity, and behavior type, and may select only activities whose score exceeds a threshold. This rule-based selection mechanism is implemented as part of the data analysis module and reduces unnecessary model invocations, thereby decreasing computational load and network traffic associated with remote model inference.

The server stores the generated questions in the storage device in association with the corresponding activity identifier, behavioral feature data, and prompt sentence. The server assigns a question identifier to each generated question and maintains an index that links question identifiers, activity identifiers, and user identifiers. This linked data structure allows efficient retrieval of questions and associated context for subsequent display or analysis. The server also records the prompt sentence used for each question, allowing post-hoc evaluation of prompt effectiveness and enabling adaptive changes to the prompt template based on observed model performance.

The terminal is, for example, a smartphone, tablet, or other user-operated computing device. The terminal includes a display unit, an input unit, a processor, a memory, and a communication interface. The terminal executes a client application specifically designed to interact with the server. The terminal receives, via the communication interface, question data and associated activity context from the server in a structured format and stores the received data in a local storage module. The terminal displays the questions and, where appropriate, thumbnail images or activity metadata on the display unit, using a user interface framework. The user views the questions on the terminal and inputs answer information using the input unit, such as a touch keyboard or voice input that is transcribed to text. The terminal generates structured answer records containing at least a question identifier, answer text, and timestamp, and transmits these records to the server. The terminal may also maintain a local cache of answer records to allow offline review. In this way, the terminal cooperates with the server to provide a responsive user interface while offloading heavy data analysis and generative processing to the server.

The server receives the answer information from the terminal and stores it as record information in the storage device in association with the corresponding activity information and analysis result of behavior. The server maintains a composite data structure that links each user's activities, generated questions, and answers. The server builds indexes that support time-series queries and per-behavior queries. For example, the server maintains a time-ordered index per user, and a behavior-type index that groups activities and their associated questions and answers by behavior type. This indexing scheme improves retrieval performance when searching diary information by date range, behavior category, or emotional tendency.

The server generates display data by querying the linked structure of activity information, behavioral feature data, generated questions, and answer information. The server constructs display pages or views, such as a chronological list of diary entries or a calendar view, in which each entry references its associated activity and question. By organizing data at the storage and index level, the server reduces the computation required at query time, enabling prompt response even when handling large volumes of historical records. This technical configuration improves data management efficiency and contributes to lower latency and reduced processor load compared to systems that operate on unstructured diary text without explicit linkage to structured activity features.

The system provides technical improvements over conventional computer systems in several ways. First, the server transforms heterogeneous, unstructured activity information from multiple external sources into a unified, structured behavioral feature representation. This transformation is not merely a business-level categorization but a specific computational process involving feature extraction, normalization, sentiment inference, and indexing, which improves the computer's ability to store, retrieve, and process large-scale behavioral logs with reduced computational complexity.

Second, the server uses the structured behavioral features to construct prompt sentences according to a non-generic, template-based algorithm that encodes multi-dimensional context into the input of the generative AI model. This improves the model's output quality and reduces the need for additional filtering or manual editing, thus increasing both accuracy and computational efficiency. Because the model receives more precise context, it can generate relevant questions with fewer tokens and fewer iterations, which reduces processing time and bandwidth between the server and a remote model hosting environment.

Third, the server maintains explicit associations between activity information, analysis results, generated questions, and answer information, enabling structured, machine-usable diary data rather than free-form text. This structure allows the server to implement efficient indexing and retrieval algorithms, resulting in faster queries and more accurate filtering. The server can, for example, quickly identify all diary entries related to a particular emotional tendency or location without performing expensive full-text searches.

Fourth, the generative AI model is configured and trained to operate on the specific, structured prompt sentences produced by the server, rather than on arbitrary conversational inputs. This specialization allows the model to exploit the regularity of the prompt structure, thereby reducing model uncertainty and improving output stability. The server can also tune decoding parameters and model selection based on observed performance metrics captured in the storage device, enabling adaptive optimization of the generative process.

In addition, the system implements AI processing according to rules and flow not conventionally performed by human operators. For example, the server automatically determines which activities merit question generation based on quantitative behavioral features and emotional tendency scores, applies a specific prompt template parameterized by these features, and invokes the generative AI model according to system-level constraints such as daily generation quotas or resource limits. This non-human, algorithmic control sequence is specifically designed to optimize computational resources and output relevance and cannot be trivially replicated by human journaling practices.

In another embodiment, the server may host the generative AI model locally. In such a configuration, the server allocates GPU memory, loads model parameters from a model storage device, and performs forward passes through the neural network for each prompt sentence. The server may batch multiple prompts to improve GPU utilization. The server adjusts batch size, sequence length, and other inference parameters to achieve a balance between throughput and latency. This local hosting configuration demonstrates a clear technical interaction between model structure, hardware resources, and data flow, showing that the claimed system is directed to specific computer technology improvements.

In yet another embodiment, the server uses different sentiment analysis methods or different generative AI models. For example, the server may use a recurrent neural network for sentiment classification instead of a transformer, or may combine lexicon-based scores with neural scores for emotional tendency information. The server may also employ a different generative architecture, such as an encoder-decoder model, for question generation. These variations illustrate that the claimed invention can be implemented using different, but still concrete, computational architectures while maintaining the same core technical features of structured feature extraction, template-driven prompt construction, and linked diary data storage.

The terminal may also vary. In one embodiment, the terminal is a wearable device with a smaller display, and the server adapts the display data format to the terminal capabilities. In another embodiment, the terminal is a desktop computing device. In each case, the division of labor between the server and the terminal remains consistent: the server performs heavy data analysis and generative processing, while the terminal focuses on user interaction and local caching.

Because the server enforces a particular data structure, processing pipeline, and model interaction protocol, the system as a whole improves the functioning of the computer in handling large volumes of heterogeneous user activity data, generating high-quality natural language outputs with reduced computational cost, and maintaining linked diary records that are efficiently searchable and analyzable. The combination of these technical features provides improvements in processing speed, output accuracy, data management, and resource utilization, thereby demonstrating that the invention is directed to a specific technological solution rather than an abstract idea.

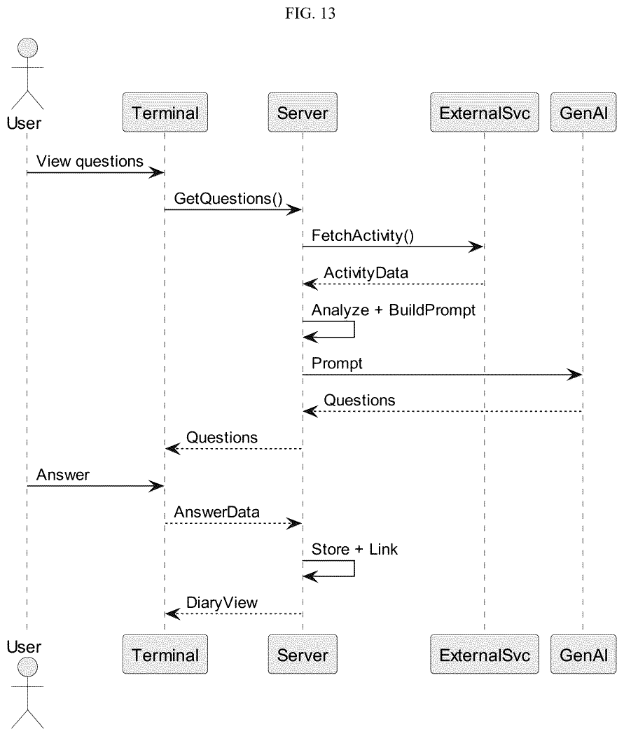

The following describes the processing flow using FIG. 13.

### Step 1:

The server acquires activity information of a user from one or more external information processing apparatuses or external information providing apparatuses via a communication network.

The server receives, as input, authentication data for the user and API endpoint information for external services that maintain posting information, image information, and location information. The server transmits authenticated HTTP requests including user identifiers and time ranges to these external services and receives, as raw output, structured response data containing text posts, image metadata, image URLs, and geographic coordinates. The server parses the response data into internal records and stores the raw activity information in a storage device with assigned activity identifiers.

### Step 2:

The server normalizes and enriches the acquired activity information to generate behavioral feature data.

The server takes, as input, the stored activity records that include timestamps, raw text, image metadata, and location coordinates. The server converts timestamps into a unified time zone and derives additional time information such as day-of-week and time-of-day category by arithmetic operations on the timestamp values. The server calls a geocoding service using the location coordinates to obtain normalized location information such as region names and place categories, and writes these into the records. The server applies rule-based classification logic to metadata fields to determine behavior type information, such as classifying an activity as an image-post event or a location-visit event, and outputs normalized behavioral feature records containing time information, location information, and behavior type information for each activity identifier.

### Step 3:

The server derives emotional tendency information from the user's posting information and related context.

The server uses, as input, textual posting information and associated metadata such as activity type and time-of-day from the normalized records. The server performs natural language preprocessing, including tokenization, lowercasing, and removal of stop words, and transforms tokens into numerical embeddings using a pre-trained embedding model. The server feeds the embeddings into a sentiment analysis model, for example a transformer-based neural network, which computes, through matrix multiplications and non-linear activation functions, a probability distribution over sentiment categories. The server interprets this distribution as emotional tendency information, such as positive, negative, or neutral with associated confidence scores, and writes these values back into the behavioral feature records, producing as output an analysis result of behavior for each activity.

### Step 4:

The server stores and indexes the behavioral feature data and analysis results for efficient retrieval.

The server reads, as input, the updated behavioral feature records including time information, location information, behavior type information, and emotional tendency information. The server inserts these records into relational tables in the storage device and creates index entries keyed by user identifier, activity identifier, and time fields. The server also maintains secondary indexes based on behavior type and emotional tendency categories. By executing structured insert and index operations, the server outputs a set of indexed tables that allow subsequent queries to locate relevant activity and behavior analysis records with reduced search time.

### Step 5:

The server selects candidate activities for question generation based on predefined criteria.

The server uses, as input, the indexed behavioral feature data and analysis results stored in the database. The server executes selection queries that filter activities by conditions such as recency, completeness of time and location fields, and minimum confidence threshold of emotional tendency scores. The server may compute a relevance score for each candidate by applying a deterministic function that combines recency, emotional intensity, and behavior type weights. The server compares the relevance score with a threshold and selects only those activities whose score exceeds the threshold. The server outputs a list of selected activity identifiers with associated feature records as candidates for generating questions.

### Step 6:

The server constructs a prompt sentence for each selected activity using a template-based algorithm.

The server takes, as input, the selected activity identifiers and their associated behavioral feature data and raw activity information, including date, location, activity description, original comment, and emotional tendency. The server retrieves a predetermined natural language template that defines placeholders for these elements. The server then performs string formatting operations, replacing placeholders with concrete values, and concatenates lines to form a coherent prompt sentence. For example, the server may output a prompt sentence such as:

“Generate 3 reflective questions about the following activity.
Date: 2023 Oct. 5
Location: Tokyo, Japan
Activity description: The user took a photo of a city skyline at sunset with orange and pink colors.
User's original comment: ‘Beautiful sunset today!’
Detected sentiment: positive, calm Focus on the user's feelings, thoughts, and personal meaning behind this moment. Output the questions in English, each on a separate line.”

The server stores each generated prompt sentence together with the corresponding activity identifier as output.

### Step 7:

The server invokes a generative AI model using the constructed prompt sentence and obtains introspective questions.

The server uses, as input, the stored prompt sentence and configuration parameters for the generative AI model such as maximum token length, temperature, and number of questions to generate. The server encodes the prompt sentence into a token sequence and submits the tokens to the generative AI model, which is implemented, for example, as a transformer-based language model with multiple attention layers. Within the model, the processor performs matrix multiplications, attention weight calculations, and non-linear transformations to compute output token probabilities. The server applies a decoding algorithm, such as greedy decoding or beam search, to these probabilities to generate natural language questions. The server receives, as output, one or more introspective questions in text form and associates them with the corresponding activity identifier and prompt sentence in the storage device.

### Step 8:

The server packages the generated questions and related activity context for delivery to a terminal.

The server reads, as input, the generated question texts, their question identifiers, and the associated activity context including thumbnail image URLs and summarized time and location information. The server constructs a structured response object, grouping questions per user and per activity, and includes fields such as question identifier, question text, activity date, activity location, and a reference to image information. The server serializes this object into a response message and outputs the response message over the communication network to the terminal as a payload ready for display.

### Step 9:

The terminal receives the question payload and prepares user interface elements for display.

The terminal uses, as input, the response message from the server containing question data and associated activity context. The terminal parses the message into internal data structures, such as objects that represent each question and its metadata, and stores them in local memory or local storage. The terminal then constructs user interface elements, mapping each question to a visual component that includes text fields for the question and optional image thumbnails or location labels. The terminal outputs a rendered user interface on the display unit that shows the questions and provides input controls.

### Step 10:

The user reviews the displayed questions on the terminal and inputs answer information.

The user receives, as input, the visual presentation of questions and any associated images or context on the terminal display. The user reads each question and uses the terminal's input unit, such as a touchscreen keyboard or voice input interface, to compose a free-form textual answer that reflects internal thoughts and feelings. The user may edit the text within the input field and confirms the entry by activating a control, such as a submit button. The user's action produces, as output, answer information that the terminal can capture as a structured record.

### Step 11:

The terminal records the user's answer and transmits it to the server.

The terminal takes, as input, the text of the user's answer, the question identifier associated with the displayed question, and a current timestamp obtained from the terminal's clock. The terminal creates an answer record that combines the question identifier, the answer text, and the timestamp, and temporarily stores this record in a local database. The terminal then formats the record into a transmission message and sends the message through the communication interface to the server. The terminal outputs both a local stored record for offline access and a network message conveying the answer information to the server.

### Step 12:

The server stores the answer information as record information linked to the activity and analysis results.

The server receives, as input, the transmission message from the terminal containing the question identifier, answer text, and timestamp. The server validates the message by checking the user identity and verifying that the question identifier exists and is associated with the same user. The server then writes a new record into a diary or answer table in the storage device, linking the answer record to the corresponding question identifier, activity identifier, and analysis result of behavior via foreign keys. The server outputs an updated, linked data structure in which each answer is stored as record information associated with specific behavioral context and emotional tendency.

### Step 13:

The server generates display data for time-series or behavior-based presentation of diary information.

The server uses, as input, the linked tables containing activity information, behavioral feature data, generated questions, and stored answer information. The server executes query operations that join these tables by user identifier and apply ordering or grouping conditions, such as sorting by activity date or grouping by behavior type. The server then formats the query results into display data structures suitable for different views, such as a chronological list or a calendar grid, including summary fields like date, location, question text, and a preview of the answer text. The server outputs this display data to the terminal, which can render the diary information efficiently for the user's later review.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog and diary systems that use natural language processing and emotion analysis typically operate on a single, narrow type of input, such as free-form text, and generate static questions or fixed templates. Such systems have several technical limitations. First, they do not effectively integrate heterogeneous contextual signals, such as image data, location information data, and activity information obtained from external information services, into a unified representation that can drive adaptive interaction. As a result, server-side processing cannot accurately infer where and when user events occurred, or which user actions are most likely to be emotionally significant, which leads to low-relevance prompts and questions.

Second, even when emotion analysis is applied, known systems generally use the emotion result only once to select a pre-defined question or template, and do not tightly couple the emotion analysis pipeline with construction of detailed prompt sentences for a generative AI model. The server therefore cannot express, at the prompt level, a rich task specification including task type, spatiotemporal context, and emotion state. This causes generative models to produce generic or noisy outputs that are poorly aligned with the user's actual situation, thereby wasting computational resources and decreasing system responsiveness.

Third, conventional architectures do not implement an iterative interaction control loop in which the server repeatedly generates follow-up prompt sentences based on newly received user responses and updated emotion analysis results. Without such a loop, the system cannot adapt the depth, tone, and content of generated questions and content over the course of a session. This reduces the granularity and accuracy of collected data and prevents the system from automatically generating high-quality diary data or aggregated analytics that are useful for service improvement.

Fourth, existing systems do not provide a systematic mechanism for the server to update and refine prompt sentence generation rules over time based on transitions in user emotion state and user activity history. As a result, prompt generation remains static and rule-based, rather than being personalized per user. This limits the ability of the server to improve interaction efficiency and user satisfaction as more data is accumulated.

Finally, known solutions generally treat generated diaries and emotion-labeled responses as isolated outputs and do not perform server-side, group-level analysis to extract emotion tendencies, behavior tendencies, and evaluation tendencies for later use in generating operator-facing summaries and improvement suggestions. Consequently, backend computing resources are not leveraged to transform large volumes of interaction logs into structured, high-level insights, and the overall information processing system does not fully exploit collected data to improve subsequent computational behavior.

Accordingly, there is a need for a computer-implemented system and server architecture that: (i) acquires and stores heterogeneous user input information including text, images, location information, and external activity information; (ii) integrates such information with emotion analysis to compute context information including event-likely points; (iii) uses the context information to construct detailed prompt sentences for a generative AI model specifying task type, spatiotemporal information, and emotion information; (iv) controls iterative interactions with the generative AI model by generating follow-up prompt sentences based on user responses and updated emotion analysis; and (v) automatically generates and stores diary data and aggregated information, and further analyzes such stored data to produce summary and improvement information. By solving these problems, the invention improves the way a server processes, orchestrates, and utilizes multi-modal and emotional interaction data, thereby improving the functioning of the underlying computer system itself.

The specific processing by the specific processing unit 290 of the data processing device 12 in Application Example 2 is realized by the following means.

The present invention provides a server comprising a processor configured to receive, from a user terminal and from an external information service, input information including text data, image data, location information data, and activity information, to store the input information in a storage medium, to analyze the text data using natural language processing and emotion analysis to identify a user emotion state and a user behavior content, to integrate the image data, the location information data, and the activity information to extract, within a physical area, a point at which an event is estimated to have occurred, and to generate context information including the user emotion state and information relating to the point at which the event is estimated to have occurred; the processor further configured to construct, based on the context information and an interaction purpose including at least one of a dialogue mode and a content generation mode, a prompt sentence to be input to a generative AI model, the prompt sentence including at least a task type, spatiotemporal information, and emotion information; the processor further configured to cause the generative AI model to receive the prompt sentence, to obtain output text from the generative AI model including at least one of a question sentence, a diary sentence, and personalized content, to format the output text as response information for presentation to the user terminal, and to accumulate the response information and a response content from the user to the response information in the storage medium; the processor further configured to generate a follow-up prompt sentence for eliciting additional input based on the response content from the user and a re-performed emotion analysis result corresponding to the response content, and to repeatedly execute an interaction process with the generative AI model using the follow-up prompt sentence; and the processor further configured to automatically generate and record, based on the input information, the response content, and emotion analysis results corresponding thereto, at least one of diary data reflecting a user experience and a user emotion and aggregated information for service improvement, and to analyze accumulated diary data, response contents, and emotion analysis results to extract, at a group level, emotion tendencies, behavior tendencies, and evaluation tendencies and to generate, based on the extracted tendencies, summary information, improvement suggestion information, or recommendation information for an operator. This enables the server to technically improve the way heterogeneous interaction data is processed by integrating multi-modal inputs into context information, by encoding that context into structured prompt sentences for a generative AI model, by adaptively controlling iterative question-answer cycles based on updated emotion analysis, and by automatically transforming large-scale stored results into personalized outputs and operator-facing analytics, thereby enhancing the efficiency, accuracy, and adaptability of the overall computer-implemented interaction system.

The term “processor” refers to one or more hardware logic circuits, such as a central processing unit, a microprocessor, or another programmable computation element, configured to execute instructions and perform the operations described herein.

The term “storage medium” refers to any non-transitory computer-readable medium capable of storing digital information, including but not limited to semiconductor memory, magnetic storage, and optical storage.

The term “user terminal” refers to an information processing device operated by a user, such as a mobile communication device, a tablet device, a desktop computer, or a notebook computer, configured to send data to and receive data from the server.

The term “external information service” refers to a network-accessible information providing system, such as a social networking service, a media storage service, or an application programming interface, from which user-related activity information can be acquired.

The term “input information” refers to information received by the server from the user terminal and the external information service, including at least text data, image data, location information data, and activity information.

The term “text data” refers to character-based information representing user input sentences, comments, answers, diary fragments, or other linguistic expressions suitable for natural language processing.

The term “image data” refers to digital image information acquired from an image capturing device or a storage component, including but not limited to photographs and screenshots, optionally including associated metadata.

The term “location information data” refers to digital data indicating a geographic position or movement of a user or user terminal, such as coordinates, area identifiers, or time-stamped position logs, obtained for example from a positioning system.

The term “activity information” refers to digital records related to user actions or experiences, including but not limited to social media posts, content viewing histories, purchase histories, check-in logs, and other behavior logs acquired from an external information service.

The term “natural language processing” refers to computational techniques that analyze, interpret, or transform human language text, including but not limited to tokenization, part-of-speech tagging, syntactic parsing, semantic analysis, and key phrase extraction.

The term “emotion analysis” refers to a computational process for estimating an emotional state from input information, such as classifying text or other data into categories like positive, negative, neutral, or specific emotions such as happiness, fatigue, or stress.

The term “user emotion state” refers to an estimated emotional condition of a user at a particular time, represented for example by one or more emotion labels, scores, or categories derived from emotion analysis.

The term “user behavior content” refers to information describing a user's actions, activities, or experiences, derived from analysis of text data, image data, location information data, and activity information.

The term “physical area” refers to a real-world spatial region, such as a store, a facility, a neighborhood, or another geographic zone, in which user activities or events can occur.

The term “point at which an event is estimated to have occurred” refers to a position or spatiotemporal segment within a physical area that the server determines, based on integrated input information, as likely corresponding to a meaningful user activity or experience.

The term “context information” refers to a structured representation that includes at least a user emotion state, information relating to a point at which an event is estimated to have occurred, and optionally additional user-related or environment-related parameters used to guide generative processing.

The term “interaction purpose” refers to a processing objective for a session with a user, including at least one of a dialogue mode in which questions and answers are exchanged, and a content generation mode in which narrative or recommendation content is produced.

The term “dialogue mode” refers to an interaction mode in which the system generates question sentences or conversational outputs and receives corresponding responses from the user in a turn-based manner.

The term “content generation mode” refers to an interaction mode in which the system generates non-interrogative content, such as diary sentences, stories, summaries, or recommendation texts, based on user-related information.

The term “prompt sentence” refers to a natural language or structured instruction text constructed by the server and provided as input to a generative AI model, specifying at least a task type, spatiotemporal information, and emotion information to control the model's output. The term “generative AI model” refers to a machine-implemented model that generates text or other content in response to given input, such as a neural network-based natural language generation model conditioned by a prompt sentence.

The term “task type” refers to a classification of a generation objective, such as question generation, diary generation, summary generation, personalized content generation, or recommendation generation, specified in a prompt sentence.

The term “spatiotemporal information” refers to information describing time and place, including for example timestamps, time ranges, locations, and movement patterns associated with user events.

The term “emotion information” refers to data embedded in or referenced by a prompt sentence that represents one or more user emotion states or emotion tendencies relevant to the generation task.

The term “output text” refers to textual data produced by the generative AI model in response to a prompt sentence, including at least one of a question sentence, a diary sentence, and personalized content.

The term “question sentence” refers to output text formulated as an interrogative expression intended to elicit further information, feelings, or evaluations from the user.

The term “diary sentence” refers to output text formulated as a narrative or reflective expression representing user experiences and emotions, suitable for storage as part of a diary entry.

The term “personalized content” refers to output text adapted to a specific user based on that user's emotion state, activity history, and context information, including for example stories, advice, or recommendations.

The term “response information” refers to formatted output text prepared by the server for presentation to the user terminal, including generated questions, diary sentences, or personalized content.

The term “response content” refers to data representing a user's reply or reaction to response information, including textual answers, selections, confirmations, or other user inputs.

The term “follow-up prompt sentence” refers to a prompt sentence constructed based on at least one response content and a corresponding updated emotion analysis result, and used to obtain additional or deeper information from the generative AI model.

The term “interaction process” refers to a sequence of operations in which the server exchanges prompt sentences and model outputs with the generative AI model and exchanges response information and response contents with the user terminal.

The term “diary data” refers to structured or semi-structured data comprising one or more diary sentences and associated metadata, representing a record of a user's experiences and emotions over time.

The term “aggregated information for service improvement” refers to information produced by combining and analyzing multiple users' data, such as statistics or summaries used to evaluate and improve services, products, or environments.

The term “activity history” refers to a temporal record of user behaviors or interactions, including past input information, response contents, detected events, and emotion states associated with those behaviors.

The term “prompt sentence generation rules” refers to parameters, templates, or algorithms used by the processor to construct prompt sentences, which can be learned or adjusted based on accumulated interaction data.

The term “emotion tendencies” refers to patterns or distributions of emotion states observed across multiple users or over time, such as frequently occurring emotions or typical emotional shifts.

The term “behavior tendencies” refers to patterns or distributions of user actions or activities observed across multiple users or over time, such as common visit sequences, purchase patterns, or interaction habits.

The term “evaluation tendencies” refers to patterns in users' evaluations, opinions, or satisfaction levels regarding entities such as products, services, or environments.

The term “summary information” refers to compact representations derived from larger datasets, such as overviews, highlights, or condensed descriptions of user emotions, behaviors, or evaluations.

The term “improvement suggestion information” refers to information that proposes modifications or enhancements to services, products, or operations, generated based on analyzed diary data, response contents, and emotion analysis results.

The term “recommendation information” refers to information specifying items, actions, or services proposed to users or operators based on extracted tendencies and context information.

In one embodiment, a server, a user terminal, and one or more external information services cooperate to implement the claimed system. The server comprises at least one processor, a main memory, a non-transitory storage medium such as a magnetic or semiconductor storage device, and a network interface. The terminal comprises a processor, a display, input devices such as a touch panel or keyboard, a camera, a location sensor, and a wireless communication interface. The external information services comprise network-accessible computing systems that expose application programming interfaces (APIs) for providing user-related activity information.

The server executes server-side software implemented, for example, using a general-purpose programming language and a web application framework. The server software includes modules for communication management, data ingestion, natural language processing, emotion analysis, context synthesis, prompt sentence generation, model interface control, result post-processing, and data analytics. The server uses a database system such as a relational database management system or a document-oriented database, and may additionally employ a distributed object storage service for storing large text and image objects. The terminal executes client-side software such as a native mobile application or a web application, responsible for user authentication, user interface presentation, local data collection, and message transmission to and from the server.

The server uses a natural language processing library, for example an open-source toolkit that performs tokenization, part-of-speech tagging, syntactic dependency parsing, and named entity recognition. The server additionally uses an emotion analysis model implemented as a neural network, for example a multi-layer bidirectional recurrent neural network or transformer encoder trained on emotion-labeled text. The neural network accepts as features token embeddings, positional encodings, and additional metadata features such as time of day or content source, and outputs a vector of emotion scores. The server uses a generative AI model implemented as a transformer-based language model with multiple self-attention layers, feed-forward layers, and layer normalization components. The generative AI model is accessed via an API, and the server provides prompt sentences and receives generated text sequences from the model.

The server maintains data structures that represent individual user sessions and accumulated histories. In one example, the server stores, for each user, an activity history record comprising a sequence of entries. Each entry includes fields for a timestamp, a location identifier, one or more image references, one or more text segments, a set of emotion scores, and one or more event-likelihood scores. The server stores prompt sentences and corresponding model outputs in association with session identifiers and user identifiers. The server further stores context information records, each representing a unified representation of a particular situation, including a user emotion state, a set of event-likely points, and spatiotemporal attributes.

The terminal acquires input information from the user and from hardware sensors. The terminal displays user interface elements such as text input fields, photo selection controls, and buttons for granting permission to access camera and location information. The user enters text such as “Today I went to the park with my friends and had a picnic” or “I feel very tired today.” The user may select one or more photos from a camera roll or capture a new photo. The terminal reads image files and may also read image metadata including capture time and approximate location. The terminal retrieves current location information from a positioning subsystem of the device and may optionally retrieve recent movement history. The terminal encapsulates such data into a structured message and transmits the message via the network interface to the server.

The server receives the message and stores the raw input into the storage medium. The server then performs data processing using the above-described software modules. The server applies natural language processing to text segments to obtain token sequences, part-of-speech tags, and syntactic dependency trees. The server feeds the token sequences, enriched with metadata such as language identifier or content type, into the emotion analysis neural network. The neural network has been trained using supervised learning with a loss function such as cross-entropy loss over emotion labels, and with an optimizer such as stochastic gradient descent or an adaptive gradient method. During training, the neural network processes mini-batches of training sentences, computes emotion scores, compares them to ground-truth labels, calculates loss, and updates network weights based on gradients computed by back-propagation. The server stores the trained model parameters in the storage medium and loads them into memory at runtime.

The server uses the emotion scores to define a user emotion state, such as “happy,” “tired,” or “stressed,” together with confidence values. The server then integrates image data and location information data. The server parses image metadata to extract capture time and inferred geolocation. The server uses a spatial indexing structure, such as a grid index or R-tree, to map location coordinates to physical areas such as specific store zones, districts, or facilities. The server optionally queries external information services, using their APIs, to obtain activity information for the same time period, such as social media posts or purchase logs. The server aggregates these data into an intermediate context structure. The server applies an algorithm that groups data by time windows and spatial proximity to identify event-likely points. For example, the server may compute, for each time interval and physical area, the number of photos taken, the duration of stay, and the intensity of emotion scores, and may designate as event-likely points those intervals with high combined scores. The server records information indicating each event-likely point and associated attributes (time range, coordinates, detected objects, predominant emotion).

Based on the emotion state and event-likely points, the server generates context information for the current user session. The server then constructs a prompt sentence to be sent to the generative AI model. The server uses one or more templates and rule sets stored in the storage medium. Each template defines positions and syntactic structures for inserting task type keywords, time expressions, place descriptions, emotion words, and desired output style. The server selects a template based on an interaction purpose, such as question generation, diary generation, or personalized recommendation generation. The server fills the template with values derived from context information, such as the name of a physical area, the type of product in the photo, and emotion descriptors.

In one concrete example, when the user has taken a photo of a newly displayed product in a physical store and the emotion state indicates positive interest, the server constructs a prompt sentence such as:

“The user is currently in a clothing store and has taken a photo of a new red dress. Emotion analysis indicates a positive and interested feeling. Generate two open-ended questions to explore the user's first impression and reasons for liking or disliking this red dress.”

In another example, when the user has typed a short description of the day and the emotion state indicates happiness, the server constructs a prompt sentence such as:

“Based on the following short input and the detected emotion ‘happy’, generate a detailed diary entry in the first person. Use a warm and reflective tone. User input: ‘Today I went to the park with my friends and had a picnic.’”

In another example, when the user indicates fatigue, the server constructs a prompt sentence such as:

“The user feels very tired today. Generate a short story and three practical tips that can help the user relax and recover from fatigue. Use an empathetic and encouraging tone.”

The server supplies the prompt sentence to the generative AI model. The generative AI model is a transformer-based language model comprising multiple stacked self-attention blocks, each block including multi-head attention layers and position-wise feed-forward layers. The model has been pre-trained on large corpora of text data using an auto-regressive language modeling objective, where the model predicts the next token based on previously seen tokens, and uses a loss function such as cross-entropy to train model weights. The model is configured with a vocabulary, embedding dimension, number of layers, and number of attention heads. During inference, the model receives the prompt sentence as a sequence of tokens, computes contextualized token representations using self-attention, and iteratively predicts new tokens to generate output text until an end condition is reached.

The server controls decoding parameters such as maximum output length, sampling temperature, or top-k/top-p sampling thresholds. The server thereby affects the diversity and determinism of generated text. The server receives the output text from the generative AI model and performs post-processing operations, such as trimming, sentence boundary detection, and segmentation into individual question sentences when multiple questions are generated. The server stores the output text in association with the prompt sentence and context information.

The terminal receives the output text and presents it to the user. For example, the terminal displays generated questions within a conversation interface, or displays generated diary text within a diary viewing screen. The user reads the questions and enters responses using text input or selection controls. The terminal transmits the user responses to the server. The server treats the responses as new input information, again performs natural language processing and emotion analysis, and updates the user emotion state and context information.

The server constructs follow-up prompt sentences that reflect both the previous model outputs and the newly received responses.

For example, when the user answers a question about a product by writing that the design feels elegant and the color suits them, the server may construct and send to the generative AI model a follow-up prompt sentence such as:

“The user answered that they liked the elegant design and the way the red color suited them. Generate one follow-up question to explore whether they would actually purchase this dress and what might prevent them from doing so.”

By repeating this process, the server implements an iterative interaction loop. The server does not simply substitute a human interviewer, but instead uses dynamic context synthesis, emotion-aware prompt construction, and model-guided question refinement that adjust the depth and direction of the interaction in real time. The server thereby reduces redundant questions, focuses on emotionally salient topics, and improves the efficiency of information collection as compared with fixed rule-based scripts.

The server also generates diary data using the generative AI model. The server aggregates input information and response contents for a given day or session, computes a summary representation (such as a fixed-length vector embedding that encodes topics and emotions), and constructs a diary generation prompt sentence that specifies the desired narrative style and content coverage. The server supplies this prompt sentence and receives one or more diary sentences capturing the user's experience and emotional trajectory. The server stores the diary data, including the generated text, metadata such as date and dominant emotions, and links to underlying raw inputs.

The server performs additional analytics on stored diary data, response contents, and emotion analysis results across multiple users. The server executes batch processing jobs that perform clustering, dimensionality reduction, or topic modeling, to identify group-level emotion tendencies, behavior tendencies, and evaluation tendencies. The server then constructs operator-facing prompt sentences summarizing such findings. For example, the server may construct a prompt sentence such as:

“Summarize the main positive and negative emotions expressed by users about the fitting room area of a store during the last week, and list three concrete improvement suggestions based on their comments.”

The generative AI model generates a concise report. The server stores or displays this report to an operator. By structuring and compressing large-scale logs of interaction into higher-level analytics, the server reduces the cognitive load on human analysts and provides machine-generated insights that are difficult to derive manually at scale.

This architecture provides several technical improvements over conventional systems. First, the server integrates heterogeneous data types (text, images, location information, external activity logs) into a structured context representation and uses a specific algorithm for detecting event-likely points. This reduces the search space of possible user events and allows the server to focus computational resources on segments of high informational value. As a result, the server improves processing efficiency and reduces unnecessary communication between the terminal and the server.

Second, the server encodes task type, spatiotemporal information, and emotion information explicitly into prompt sentences. By doing so, the server aligns the generative AI model's internal inference process with context information already computed on the server. This reduces the need for the model to infer context from scratch and significantly improves the relevance and coherence of generated outputs. Such alignment reduces wasted computation in the generative model and reduces the number of interaction steps required to reach a desired level of detail, thereby improving computational throughput and reducing latency.

Third, the server maintains and continuously updates prompt sentence generation rules based on user emotion transitions and activity histories. The server may, for example, store weights or parameters for choosing among different templates, and adjust these weights according to observed user engagement metrics or emotion distribution. This adaptive mechanism causes the system to converge to more effective prompt patterns for each user, which in turn improves the predictability of the generative AI model's responses and reduces the frequency of unproductive outputs. This feedback-driven refinement is not a simple automation of human behavior, but a non-conventional control loop that directly modifies the way computing resources are used, in response to accumulated machine-interpretable patterns.

Fourth, the server provides specific internal data structures and pipelines for handling the flow from input ingestion to model output and analytics. The server uses separate modules for pre-processing, model interfacing, and post-processing, with defined intermediate representations (such as tokenized text, emotion score vectors, event-likelihood maps, and context records). This modular and structured pipeline allows for parallelization and caching, which reduce processing time and memory usage. For instance, once the server computes emotion scores and event-likely points for a given input, subsequent prompt constructions can reuse these results without recomputing heavy models, thereby reducing computation and power consumption.

Fifth, the described system improves data management by linking raw inputs, context information, prompt sentences, and model outputs through persistent identifiers. This linkage enables reproducibility of generative outputs and supports fine-grained auditing and debugging of the generative AI model's behavior. When errors or undesired outputs occur, the server can reconstruct the exact context and prompt that led to the output, which assists in adjusting templates, parameters, or training data. Such traceability is a technical improvement in the management and operation of complex AI-based systems.

In alternative embodiments, the server may use different neural network architectures for emotion analysis, such as convolutional neural networks applied to character sequences, or transformer encoders with attention over multiple modalities. The server may also employ additional features, such as count-based sentiment lexicon scores, as input to the emotion model. The generative AI model may be deployed locally on the server, in a separate inference server, or accessed as a cloud service, as long as the server can transmit prompt sentences and receive generated text. The server may adapt decoding strategies, such as using beam search with a custom scoring function that penalizes repetitive or off-topic text. In further embodiments, the system can operate in environments other than physical stores, such as museums, public facilities, or outdoor venues, with the same technical advantages regarding context-aware prompt construction and emotion-aware interaction control. The terminal may be any device capable of presenting text and images and communicating with the server, including smart watches, vehicle infotainment systems, or wearable devices. In all such embodiments, the server, terminal, and external information services cooperate to implement the claimed functions. The system uses a specific combination of multi-modal data integration, emotion-aware context synthesis, structured prompt sentence generation for a generative AI model, iterative follow-up control, and group-level analytics. This combination changes the way in which computing hardware and software process and manage interaction data, providing improved processing efficiency, higher content relevance, reduced communication overhead, and better scalability as compared with conventional, purely rule-based or single-modality dialog and diary systems.

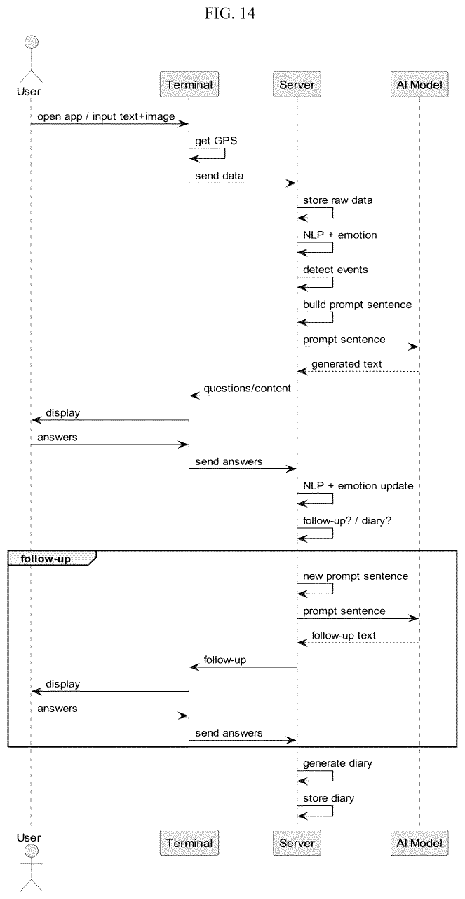

The following describes the processing flow using FIG. 14.

### Step 1:

User launches an application on the terminal and initiates an interaction.

User provides initial input such as free-text (e.g., “Today I went to the park with my friends and had a picnic” or “I feel very tired today”), optionally selects or captures one or more images, and grants permission for location acquisition.

Input: user's text, selected/captured images, and permission status.

Output: raw local input bundle held in the terminal's memory including text strings, image objects, and location permission flags.

### Step 2:

Terminal acquires sensor data and prepares a transmission packet.

Terminal calls an operating system API to obtain current location (e.g., GPS coordinates, timestamp) and reads image metadata such as capture time and embedded location from the image files.

Terminal constructs a structured message (e.g., JSON object) containing user text, image binary or image references, location coordinates, timestamps, and a user identifier.

Input: user text, image files, OS-provided location data.

Output: structured request payload ready for network transmission.

### Step 3:

Terminal transmits the structured request payload to the server over a network.

Terminal opens a secure HTTPS connection to a server endpoint and posts the payload to a REST API.

Input: structured request payload.

Output: network message delivered to the server and an HTTP response status received from the server.

### Step 4:

Server receives the payload and persists raw input.

Server parses the incoming HTTP request, validates the user identifier and data format, and extracts text data, image data or image references, location information data, and timestamps.

Server writes the extracted data to a storage medium, associating it with a new session identifier and a user identifier.

Input: structured request payload from the terminal.

Output: stored raw input records and a generated session identifier.

### Step 5:

Server augments the input with external activity information.

Server retrieves stored access tokens for external information services and calls one or more service APIs (e.g., social media, media storage, purchase history systems) to obtain recent activity logs, posts, or images corresponding to the user and to the relevant time window.

Server merges the external activity information with the raw input for the current session, constructing an extended input set.

Input: stored user identifier, session identifier, raw input records, external service tokens.

Output: extended input set containing text, images, location data, and external activity information.

### Step 6:

Server performs natural language pre-processing on text data.

Server invokes a natural language processing library to normalize user text (e.g., lowercasing when appropriate, removing extraneous whitespace), tokenize sentences and words, and compute part-of-speech tags and syntactic dependencies.

Server stores the tokenized text and linguistic annotations as intermediate data associated with the session.

Input: raw text segments from the extended input set.

Output: tokenized and annotated text structures (e.g., token lists, parse trees).

### Step 7:

Server executes emotion analysis on the text data.

Server feeds the tokenized text and optional metadata (e.g., time of day, source type) into a trained emotion analysis neural network. The neural network computes, for each text segment, a vector of emotion scores (e.g., probabilities for emotions such as happy, tired, stressed, neutral).

Server selects dominant emotions and their confidence values and stores them as a user emotion state for the session.

Input: tokenized and annotated text structures.

Output: emotion score vectors and a summarized user emotion state (e.g., label and confidence).

### Step 8:

Server processes image data and location information to derive event-likely points.

Server reads image metadata (e.g., capture time, embedded coordinates) and combines this with explicit location information data received from the terminal (e.g., current GPS coordinates, movement logs).

Server applies a spatial indexing and clustering algorithm that groups location points and timestamps into segments and computes for each segment measures such as duration, number of images taken, and average emotion scores (by aligning timestamps).

Server designates as event-likely points those segments with metrics exceeding predefined thresholds and stores their time ranges, coordinates, and associated attributes.

Input: image metadata, explicit location information data, emotion score timestamps. Output: a set of event-likely points with corresponding attributes.

### Step 9:

Server synthesizes context information for the session.

Server aggregates the user emotion state, the set of event-likely points, and selected activity information (e.g., purchased item types, visited locations) into a context record. Server structures the context record as a data object containing fields such as primary emotion, secondary emotions, list of event-likely points, store or place identifiers, and relevant activity summaries.

Input: emotion score vectors, event-likely points, external activity information. Output: context information record for the current session.

### Step 10:

Server determines the interaction purpose and task type.

Server evaluates configuration settings, current application mode (e.g., store feedback, diary generation, personalized relaxing content), and possibly user preferences or historical behavior.

Server selects one or more task types such as “question generation,” “diary generation,” or “personalized recommendation” and assigns an interaction purpose descriptor to the session.

Input: context information record, user/application settings, historical interaction data.

Output: selected interaction purpose and associated task type(s).

### Step 11:

Server selects a prompt template and constructs a prompt sentence.

Server chooses a template from a library based on the interaction purpose, emotion state, and event-likely points. Each template defines text segments and parameter slots for task type, time expressions, location descriptions, and emotion descriptors.

Server fills the template slots using data from the context information record (e.g., store type, item description, emotion labels) and constructs a full prompt sentence for the generative AI model.

Input: context information record, selected interaction purpose, prompt templates. Output: a constructed prompt sentence that encodes task type, spatiotemporal information, and emotion information.

### Step 12:

Server sends the prompt sentence to the generative AI model and configures decoding parameters.

Server calls an API endpoint of the generative AI model, transmitting the prompt sentence and generation parameters such as maximum length, sampling temperature, and nucleus sampling thresholds.

Server causes the generative AI model to process the prompt and generate a sequence of output tokens representing text.

Input: prompt sentence and decoding configuration parameters.

Output: raw generated text from the generative AI model.

### Step 13:

Server post-processes the generated text and structures it as response information. Server cleans up the generated text (e.g., trimming leading/trailing whitespace, resolving encoding issues), detects sentence boundaries, and segments the text into question sentences, diary sentences, or recommendation segments depending on the task type.

Server packages the segments into a response information object containing text fields, type labels (e.g., “question,” “diary,” “tip”), and presentation metadata (e.g., ordering). Input: raw generated text from the generative AI model.

Output: structured response information ready for delivery to the terminal.

### Step 14:

Server records the prompt-response pair and related context.

Server writes the prompt sentence, the response information, and the context information record into the storage medium under the current session identifier and user identifier.

Server thereby creates a linked record enabling later analysis and reproduction of the generative output.

Input: prompt sentence, structured response information, context information record. Output: stored interaction record associating prompt, output, and context.

### Step 15:

Server transmits the response information to the terminal.

Server formats the response information into a communication message and returns it via the existing network connection or via a push mechanism.

Input: structured response information.

Output: delivered response payload at the terminal side.

### Step 16:

Terminal renders the response information in the user interface.

Terminal parses the response payload and displays question sentences in a dialog interface, diary sentences in a scrollable text view, or personalized tips and recommendations as selectable cards.

Input: delivered response payload.

Output: graphical user interface display showing generated questions or content to the user.

### Step 17:

User reviews the displayed questions or content and provides further responses. User reads the generated questions or diary content and types free-text answers, selects predefined options, or confirms saving of a diary entry.

User actions are captured by the terminal as new response contents.

Input: displayed questions or content.

Output: user responses and confirmation actions registered in the terminal.

### Step 18:

Terminal sends user responses back to the server.

Terminal constructs a message containing the session identifier, identifiers for the questions or content elements, and the user's response contents (e.g., text answers, choice selections, confirmations).

Terminal transmits this message to the server using the communication interface. Input: user responses and associated identifiers.

Output: response message delivered to the server.

### Step 19:

Server analyzes new response contents and updates the emotion state.

Server applies the same natural language processing and emotion analysis pipeline used earlier to the user's new responses, generating updated emotion scores and possibly detecting shifts such as from “curious” to “satisfied” or from “tired” to “relaxed.”

Server updates the user emotion state in the context record for the session and logs the new analysis results.

Input: user response contents.

Output: updated emotion scores and an updated context information record.

### Step 20:

Server decides whether to generate follow-up questions or finalize a diary.

Server evaluates the updated context (e.g., remaining uncertainties, targeted depth of feedback, or diary completeness) using heuristic rules or learned thresholds.

If additional information is needed, server marks the interaction as ongoing; otherwise, server marks it as ready to finalize a diary or summary.

Input: updated context information record and predefined decision logic.

Output: decision flag indicating “follow-up required” or “finalization.”

### Step 21:

Server generates a follow-up prompt sentence when follow-up is required.

Server selects a follow-up template specialized for probing deeper into the same topic or assessing purchase intent, satisfaction, or emotional resolution.

Server inserts the latest response contents and updated emotion state into the template and constructs a follow-up prompt sentence, such as:

“The user said they liked the elegant design and the way the color suited them. Generate one question to clarify whether they intend to purchase the item now or later, and to ask what factors influence their decision.”

Input: updated context information record, stored responses, follow-up templates. Output: follow-up prompt sentence to be sent to the generative AI model.

### Step 22:

Server sends the follow-up prompt sentence to the generative AI model and obtains a new output.

Server repeats the procedure of calling the generative AI model API, now using the follow-up prompt sentence, and receives newly generated follow-up question text.

Input: follow-up prompt sentence and decoding parameters.

Output: new generated text representing follow-up questions or clarifying prompts.

### Step 23:

Server structures the new output and repeats interaction with the terminal.

Server post-processes the new generated text, converts it into response information, and sends it to the terminal, which displays the follow-up content to the user as in previous steps.

Input: new generated text from the generative AI model.

Output: additional displayed questions or content at the terminal, enabling further user responses.

### Step 24:

Server generates a consolidated diary entry when finalization is indicated.

Server aggregates the initial input, intermediate question-answer pairs, and emotion state transitions into a summary representation (e.g., by concatenating key phrases or by computing an embedding).

Server constructs a diary-generation prompt sentence such as:

“Using the following information, generate a coherent diary entry in the first person that reflects the user's day and emotions. Include the visit to the store, impressions of the red dress, and the final feeling after the interaction. Information: [structured summary].”

Server sends this prompt sentence to the generative AI model and obtains diary text. Input: aggregated interaction data and diary-generation prompt sentence.

Output: generated diary text reflecting user experience and emotions.

### Step 25:

Server stores the diary text and links it to raw data and analytics.

Server writes the generated diary text, along with references to the associated session, raw inputs, prompt sentences, and emotion analysis results, into the database. Server thereby creates a permanent diary record that can be retrieved for future viewing or analysis.

Input: generated diary text and associated metadata.

Output: stored diary record linked to underlying interaction data.

### Step 26:

Server performs offline or batch analytics on accumulated records.

Server periodically scans stored diary data, prompt-response records, and emotion analysis results for multiple users, and applies algorithms such as clustering or topic modeling to identify common emotion tendencies, behavior tendencies, and evaluation tendencies. Server produces higher-level summary or recommendation datasets that can be used to support operator-facing reports or to further refine prompt sentence generation rules.

Input: accumulated interaction records and diary data.

Output: aggregated analytics data, including extracted tendencies and summary structures, stored for use in system optimization and reporting.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

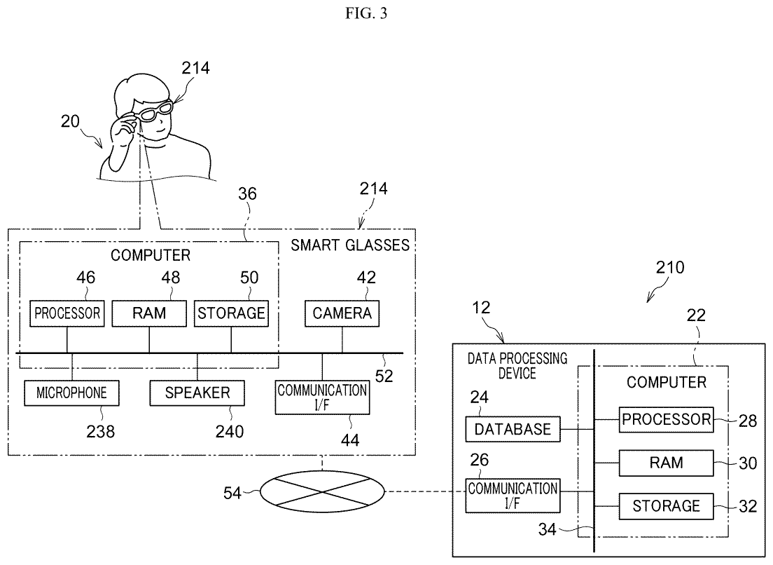

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

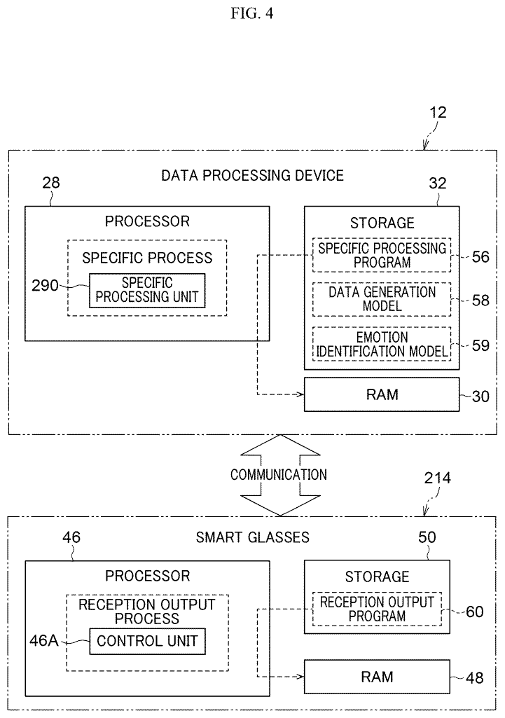

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

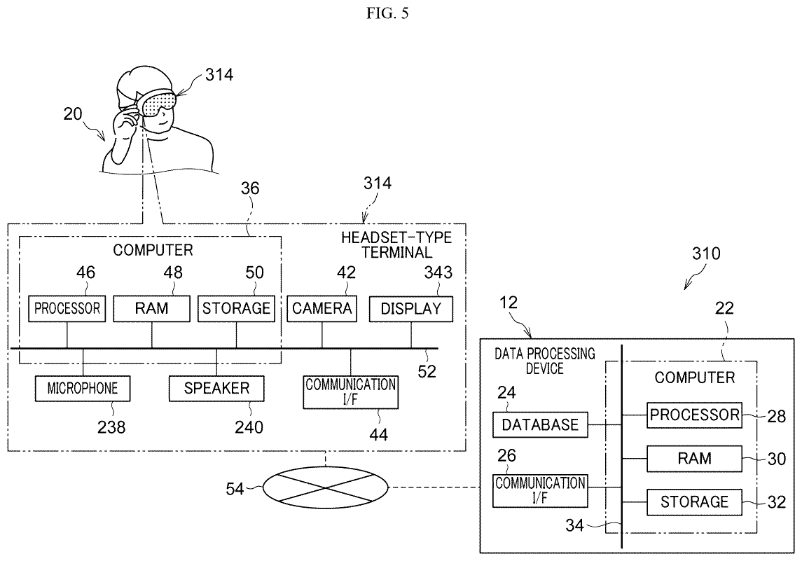

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

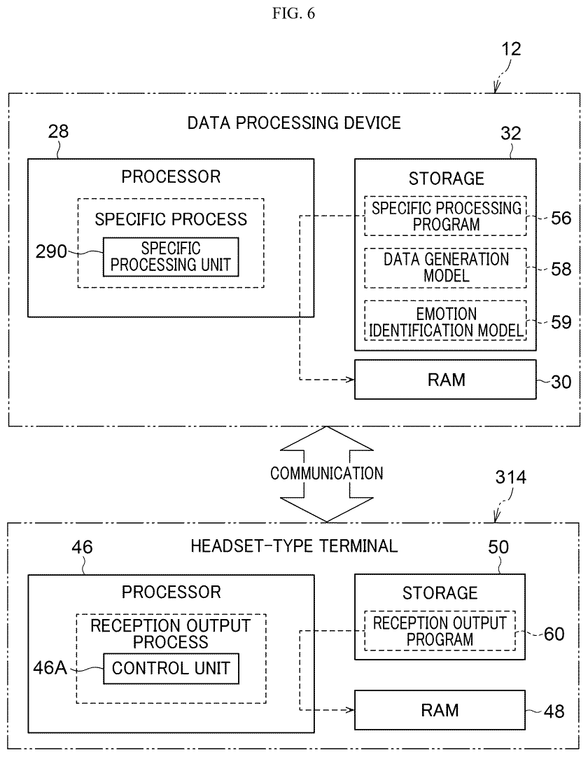

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

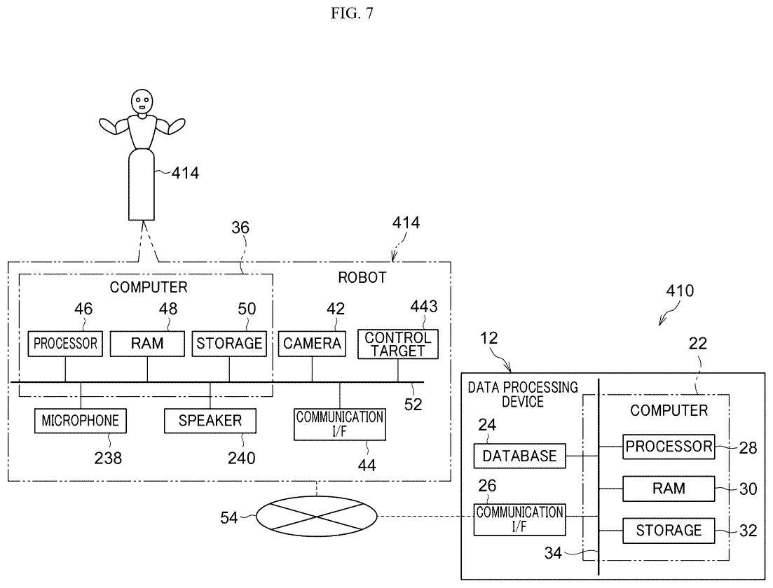

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

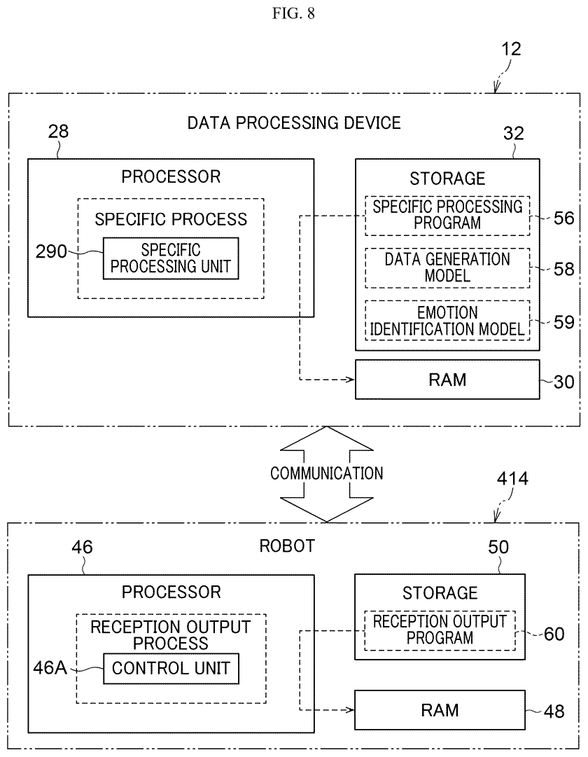

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

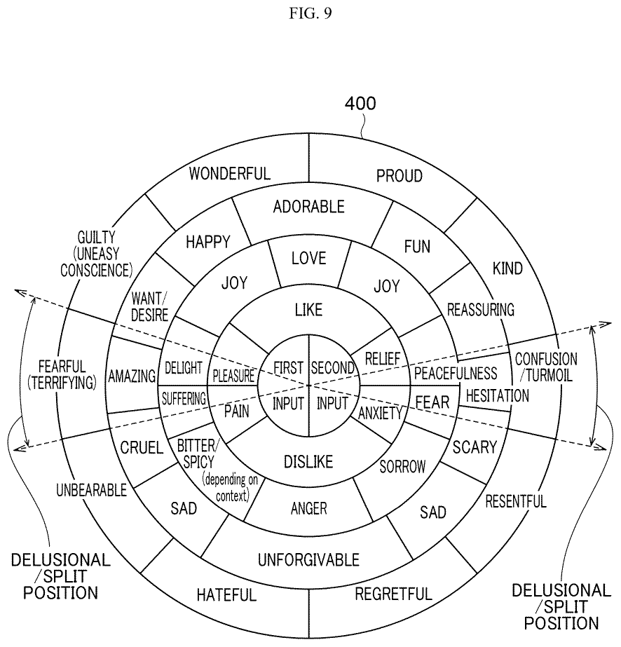

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

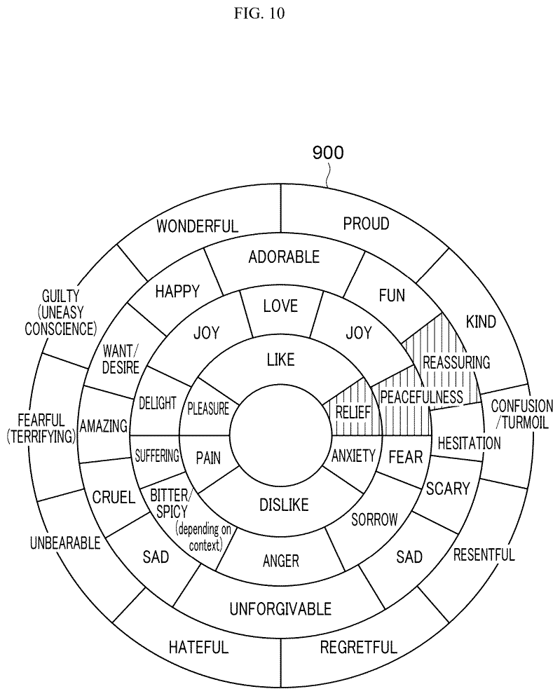

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide an information input/output interface for receiving information from a user, analyze text data obtained from the user by using a natural language processing technique to perform preprocessing including sentence segmentation, word segmentation, part-of-speech tagging, emotion estimation, and topic extraction, and to generate an analysis result including an emotional state and an area of interest of the user,
acquire the analysis result and a past answer history for each user, which are stored as structured data in a storage device, and generate user context data integrated in time series based on the analysis result and the past answer history,
create a prompt sentence to be input to a generative artificial intelligence model on the basis of the user context data, and add control conditions to the prompt sentence so as to constrain an output of the generative artificial intelligence model to a single question sentence while reflecting the emotional state and the area of interest of the user,
input the prompt sentence into the generative artificial intelligence model and cause the generative artificial intelligence model to generate, in accordance with the control conditions, a next question sentence to be presented to the user,
transmit the next question sentence via a network to a terminal device and cause the terminal device to present the next question sentence through a display user interface,
acquire answer text data of the user transmitted from the terminal device and store the answer text data, together with user identification information, question identification information, time information, and the analysis result, in a data management device,
automatically generate diary data for each user on the basis of the answer text data and the analysis result stored in the data management device, and store the diary data while maintaining a correspondence between the question sentence and the answer text data, and update, by using the diary data and the user context data, a creation policy of the prompt sentence and a generation policy of the next question sentence for a subsequent session.

### (Supplementary 2)

The system according to supplementary 1,
wherein the processor is configured to
input, to the generative artificial intelligence model, the prompt sentence together with summary information of a plurality of past question sentences and answer text data as additional context, and cause the generative artificial intelligence model to generate, as the next question sentence, a follow-up question sentence that reflects a transition of the emotional state of the user and a change in the area of interest of the user.

### (Supplementary 3)

The system according to supplementary 1,
wherein the processor is configured to
aggregate, for each predetermined period, the emotional state and a topic distribution included in the diary data stored in the data management device, generate summary information including an aggregation result, and include the summary information in the prompt sentence so as to cause the generative artificial intelligence model to generate, as the next question sentence, a question sentence that prompts the user to perform reflection on a daily unit, a weekly unit, or a monthly unit.

### Application Example 1

### (Supplementary 1)

A system comprising a processor,
wherein the processor is configured to
provide a user interface for receiving natural language input information from a user in an information processing apparatus,
analyze the input information and past input information stored in a storage device of the information processing apparatus by using natural language processing technology and emotion analysis technology to evaluate an emotional state of the user and an interest content of the user,
generate diary data as document data related to a user experience by associating an evaluation result of the emotional state and the interest content with position information and social network information acquired from an external information source, and record the diary data in the storage device,
construct a prompt sentence based on the diary data, the emotional state, the interest content, and the information acquired from the external information source so as to cause a generative artificial intelligence model to generate a next question in a dialogue format and personalized information for the user, and instruct input of the prompt sentence to the generative artificial intelligence model,
obtain the next question in the dialogue format output from the generative artificial intelligence model, and transmit the next question to a terminal device to cause the next question to be presented to the user,
obtain the personalized information output from the generative artificial intelligence model, record the personalized information in the storage device in association with the diary data, and transmit the personalized information to the terminal device to cause the personalized information to be presented to the user, and
obtain additional input or a detail information request from the user via the terminal device, update the prompt sentence based on a usage history including the additional input, and instruct the generative artificial intelligence model to execute a regeneration process based on the updated prompt sentence.

### (Supplementary 2)

The system according to supplementary 1,
wherein the processor is configured to
cooperate with the terminal device such that the terminal device displays the next question in the dialogue format received from the information processing apparatus on a display interface, acquires a natural language answer input, the position information, and the social network information from the user, and transmits the acquired information to the information processing apparatus to support generation of the diary data and generation of the personalized information by the information processing apparatus.

(Supplementary 3)

The system according to supplementary 1,
wherein the processor is configured to
construct the prompt sentence for the generative artificial intelligence model by using the diary data and the information acquired from the external information source, and instruct the generative artificial intelligence model, via the prompt sentence, to generate the personalized information including recommendation information, activity proposals, and reflection tracking questions corresponding to the emotional state and the interest content of the user.

### Example 2

(Supplementary 1)

A system comprising a processor,
wherein the processor is configured to acquire activity information of a user, the activity information including behavior-related information comprising posting information, image information, and location information obtained via a communication service from an external information processing apparatus or an external information providing apparatus, and store the activity information in a storage device,
preprocess the activity information by using a data analysis program, normalize the activity information as behavioral feature data including time information, location information, behavior type information, and emotional tendency information, and store an analysis result of behavior based on the behavioral feature data,
generate, on the basis of the analysis result of behavior and the activity information, a prompt sentence described in natural language including contextual information regarding a date and time of behavior of the user, a place of the behavior, contents of the behavior, and an emotional tendency, and input the prompt sentence to a generative AI model so as to cause the generative AI model to generate introspective questions to be presented to the user,
transmit, via a communication network, the questions generated by the generative AI model and image information or location information associated with the questions to a terminal device, and cause the terminal device to display the questions, receive, from the terminal device, answer information input by the user in response to the questions, and store the answer information in the storage device as record information in association with the activity information and the analysis result of behavior, and
generate display data for searching and presenting the record information in a time-series manner or on a per-behavior basis.

### (Supplementary 2)

The system according to supplementary 1,
wherein the processor is configured to construct the prompt sentence by fitting text data including the time information, the location information, and behavior content information obtained from the activity information and the emotional tendency information obtained as the analysis result of behavior to a predetermined template, and instruct the generative AI model to output, in a predetermined language, a plurality of open-ended questions that evoke an internal state of the user.

### (Supplementary 3)

The system according to supplementary 1,
wherein the processor is configured to store, in the storage device, the answer information of the user for each question as diary information associated with the activity information and the analysis result of behavior, and to construct the display data as diary information that is aggregated for each user and is displayable in a list format or a calendar format.

### Application Example 2

(Supplementary 1)

A system comprising a processor,
wherein the processor is configured to
receive input information including text data, image data, location information data, and activity information acquired from an external information service from a user terminal, and store the input information in a storage medium,
analyze the text data by applying natural language processing and emotion analysis to identify a user emotion state and a user behavior content, integrate the image data, the location information data, and the activity information acquired from the external information service, extract a point in a physical area at which an event is estimated to have occurred, and generate context information including the emotion state and information relating to the point at which the event is estimated to have occurred,
construct a prompt sentence to be input to a generative AI model based on the context information and an interaction purpose including at least one of a dialogue mode and a content generation mode, the prompt sentence including a task type, spatiotemporal information, and emotion information,
cause the generative AI model to receive the prompt sentence, obtain output text from the generative AI model, the output text including at least one of a question sentence, a diary sentence, and personalized content, format the output text as response information for presentation to the user terminal, and accumulate the response information and a response content from the user to the response information in the storage medium,
generate a follow-up prompt sentence for eliciting additional input based on the response content from the user and a re-performed emotion analysis result corresponding to the response content, and repeatedly execute an interaction process with the generative AI model using the follow-up prompt sentence, and
automatically generate and record at least one of diary data reflecting a user experience and a user emotion and aggregated information for service improvement based on the input information, the response content, and an emotion analysis result corresponding to the input information and the response content.

### (Supplementary 2)

The system according to supplementary 1,
wherein the processor is configured to update the prompt sentence and the output text obtained from the generative AI model in accordance with a transition of the user emotion state and an activity history of the user, and to learn or adjust future prompt sentence generation rules so as to generate, for each user, personalized question sentences, diary sentences, or personalized content.

### (Supplementary 3)

The system according to supplementary 1,
wherein the processor is configured to analyze accumulated diary data, response contents, and emotion analysis results to extract, at a group level, emotion tendencies, behavior tendencies, and evaluation tendencies, and to generate, based on the extracted tendencies, summary information, improvement suggestion information, or recommendation information for a business operator.

What is claimed is:

1. A system comprising:
circuitry configured to:
acquire, via a communication interface coupled to a packet-switched network, input text data from a terminal device;
execute a natural language processing operation on the input text data to perform segmentation and token classification, and compute an affective state classification and a topic category assignment by inputting feature representations derived from the input text data into a neural network classifier;
retrieve, from an information storage device, historical response records associated with a user identifier, and generate user context data by aggregating the affective state classification, the topic category assignment, and the historical response records into a time-series representation;
construct a constrained instruction sequence based on the user context data, the constrained instruction sequence comprising the affective state classification, the topic category assignment, and control condition parameters specifying output format constraints, and input the constrained instruction sequence into a generative neural network model comprising a transformer-based architecture to generate response prompt data;
transmit the response prompt data to the terminal device via the communication interface;
acquire reply data from the terminal device, and store the reply data in the information storage device in association with the user identifier, a session identifier, timestamp data, and the affective state classification; and
update a prompt construction policy stored in the information storage device based on the reply data and the user context data to modify control condition parameters for a subsequent constrained instruction sequence.

2. The system according to claim 1, wherein the circuitry is further configured to:
perform the segmentation by dividing the input text data into sentence units and token units, execute part-of-speech tagging on the token units, and compute the feature representations as embedding vectors using a language model applied to the tagged token units.

3. The system according to claim 2, wherein the neural network classifier comprises:
a classification model trained on labeled affective-state data using a cross-entropy loss function, the classification model configured to receive the embedding vectors and output probability values over a plurality of affective state categories, wherein the affective state classification is assigned based on the affective state category having the highest probability value.

4. The system according to claim 3, wherein the circuitry is further configured to:
extract topic indicator tokens from the input text data by applying a named entity recognition operation and a keyword extraction operation to the tagged token units, and assign the topic category by mapping the extracted topic indicator tokens to entries in a topic taxonomy stored in the information storage device.

5. The system according to claim 4, wherein the circuitry is further configured to:
generate the time-series representation by ordering the historical response records by timestamp, computing an affective state trend vector representing changes in the affective state classification across a sequence of sessions, and computing a topic frequency distribution representing relative frequencies of topic categories across the sequence of sessions.

6. The system according to claim 1, wherein the constrained instruction sequence further comprises:
a role specification parameter, a summary of the time-series representation, and a constraint parameter limiting the generative neural network model to produce a single interrogative output conforming to a specified token length range and reflecting the affective state classification and the topic category assignment.

7. The system according to claim 6, wherein the circuitry is further configured to:
include, in the constrained instruction sequence, summary data derived from a plurality of prior response prompt data and corresponding reply data, and instruct the generative neural network model to generate the response prompt data as a follow-up that reflects transitions in the affective state classification and changes in the topic category assignment across the plurality of prior sessions.

8. The system according to claim 7, wherein the circuitry is further configured to:
aggregate, for a predetermined time period, the affective state classifications and the topic category assignments stored in the information storage device, generate period summary data comprising an aggregated affective state distribution and a topic distribution for the predetermined time period, and include the period summary data in the constrained instruction sequence to cause the generative neural network model to generate the response prompt data as a reflective inquiry targeting the predetermined time period.

9. The system according to claim 1, wherein the generative neural network model comprises:
an embedding layer configured to convert input tokens into embedding vectors, a positional encoding module, a plurality of transformer layers each comprising multi-head self-attention and feed-forward sublayers with layer normalization, and a decoding stage configured to generate a probability distribution over a vocabulary and select output tokens using a sampling strategy.

10. The system according to claim 9, wherein the circuitry is further configured to:
set inference parameters for the generative neural network model comprising a temperature value, a maximum token count, and a sampling strategy selection, and adjust the inference parameters based on the affective state classification such that a lower temperature value is applied when the affective state classification indicates a high-intensity negative state.

11. The system according to claim 1, wherein the circuitry is further configured to:
generate structured document data for each user based on the reply data and the affective state classification stored in the information storage device, the structured document data comprising a document identifier, a timestamp, an association to the response prompt data, the reply data, and the affective state classification, and store the structured document data in the information storage device.

12. The system according to claim 11, wherein the circuitry is further configured to:
update the prompt construction policy by computing, from the structured document data and the user context data, a relevance score for each prior response prompt data based on a reply length metric and an affective state change metric, and adjusting weighting parameters in the prompt construction policy to increase representation of topic categories associated with higher relevance scores in subsequent constrained instruction sequences.

13. The system according to claim 1, wherein the circuitry is further configured to:
apply a validation operation to the response prompt data generated by the generative neural network model by verifying conformance to the output format constraints specified in the control condition parameters, and when the response prompt data does not conform to the output format constraints, construct a correction instruction sequence and re-input the correction instruction sequence into the generative neural network model to obtain corrected response prompt data conforming to the output format constraints.

14. The system according to claim 1, wherein the circuitry is further configured to:
acquire external context data from one or more external information sources via the communication interface, the external context data comprising at least one of position data and social activity data, and include the external context data in the constrained instruction sequence to condition the generative neural network model on contextual information external to the input text data.

15. The system according to claim 14, wherein the circuitry is further configured to:
acquire image data from the terminal device, extract visual feature data from the image data using a convolutional neural network, and include the visual feature data in the user context data to supplement the affective state classification and the topic category assignment derived from the input text data.

16. The system according to claim 1, wherein the circuitry is further configured to:
acquire activity data of the user from an external information processing apparatus via the communication interface, the activity data comprising posting data, interaction data, and location data, preprocess the activity data to normalize the activity data into behavioral feature data comprising time-indexed behavior type indicators and associated affective tendency values, and incorporate the behavioral feature data into the user context data.

17. The system according to claim 11, wherein the structured document data comprises diary entries, the response prompt data comprises questions for a journaling interaction, the reply data comprises user answers to the questions, the affective state classification identifies an emotional state of the user selected from a plurality of emotion categories, and the prompt construction policy governs generation of follow-up questions adapted to the emotional state and areas of interest of the user for an interactive diary application.

18. A system comprising:
circuitry configured to:
acquire input text data from a terminal device via a communication interface coupled to a packet-switched network;
execute a natural language processing operation on the input text data to compute an affective state classification and a topic category assignment;
retrieve historical response records from an information storage device and generate user context data by aggregating the affective state classification, the topic category assignment, and the historical response records into a time-series representation;
construct a constrained instruction sequence comprising the user context data and control condition parameters, and input the constrained instruction sequence into a generative neural network model to generate response prompt data;
transmit the response prompt data to the terminal device, acquire reply data from the terminal device, and store the reply data in association with the affective state classification in the information storage device; and
update a prompt construction policy based on the reply data and the user context data.

19. The system according to claim 18, wherein the circuitry is further configured to:
aggregate the affective state classifications and the topic category assignments for a predetermined time period to generate period summary data, and include the period summary data in the constrained instruction sequence to generate reflective response prompt data targeting the predetermined time period.

20. A method comprising:
acquiring, by circuitry via a communication interface coupled to a packet-switched network, input text data from a terminal device;
executing a natural language processing operation on the input text data to perform segmentation and token classification, and computing an affective state classification and a topic category assignment by inputting feature representations derived from the input text data into a neural network classifier;
retrieving, from an information storage device, historical response records associated with a user identifier, and generating user context data by aggregating the affective state classification, the topic category assignment, and the historical response records into a time-series representation;
constructing a constrained instruction sequence based on the user context data, the constrained instruction sequence comprising the affective state classification, the topic category assignment, and control condition parameters specifying output format constraints, and inputting the constrained instruction sequence into a generative neural network model comprising a transformer-based architecture to generate response prompt data;
transmitting the response prompt data to the terminal device via the communication interface;
acquiring reply data from the terminal device, and storing the reply data in the information storage device in association with the user identifier, a session identifier, timestamp data, and the affective state classification; and
updating a prompt construction policy stored in the information storage device based on the reply data and the user context data to modify control condition parameters for a subsequent constrained instruction sequence.
